(19) United States
(12) Patent Application Publication
(10) Pub. No.: US 2026/0203312 A1
(43) Pub. Date: Jul. 16, 2026

(54) METHOD AND DEVICE FOR DATA PROCESSING, ELECTRONIC DEVICE AND STORAGE MEDIUM

(71) Applicant: MASHANG CONSUMER FINANCE CO., LTD., Chongqing (CN)

(72) Inventor: Changlin LI, Chongqing (CN)

(21) Appl. No.: 19/326,031

(22) Filed: Sep. 11, 2025

(30) Foreign Application Priority Data
Jan. 15, 2025 (CN) 202510065319.0

(51) Int. Cl. G06F 16/31; G06F 18/214; G06F 18/22

(52) U.S. Cl. CPC G06F 16/316; G06F 18/214; G06F 18/22

(57) ABSTRACT

Data processing method, data processing device, electronic device and storage medium are provided. The method included that: a matrix of texts is constructed, and each of elements in the matrix indicates a relationship between the first text and the second text; a first dispersion of the matrix is determined based on the relationships indicated by the elements in the matrix; a first concentration of the matrix is determined based on the relationships indicated by the elements in the matrix and the first texts; and the first texts are determined as training samples in response to the first dispersion being greater than a first threshold and the first concentration being greater than a second threshold.

### CROSS-REFERENCE TO RELATED APPLICATION

This application claims priority to Chinese Patent Application No. 202510065319.0, filed on Jan. 15, 2025, the entire content of which is incorporated herein by reference in its entirety.

### BACKGROUND

With the rapid development of artificial intelligence, the effect of data processing is related to the quality of texts. The higher the quality of texts, the better the effect of data processing.

In the related art, text data processing is typically performed by evaluating each text individually. When each text meets the evaluation condition, data processing is performed based on the texts. However, since evaluating texts individually cannot accurately account for the influence between different texts, it results in relatively poor data processing performance.

### SUMMARY

The disclosure relates to the field of computer technology, and more particularly to a method and device for data processing, an electronic device and a storage medium.

Embodiments of the disclosure provide a method and device for data processing, an electronic device, a computer-readable storage medium, and a computer program product.

The technical solutions of embodiments of the disclosure are achieved as follows.

An embodiment of the disclosure provides a method for data processing, and the method includes the following operations.

A matrix is constructed. Each of elements in the matrix indicates a relationship between a first text corresponding to a row to which the element belongs and a second text corresponding to a column to which the element belongs.

A first dispersion of the matrix is determined based on the relationships indicated by the elements in the matrix.

A first concentration of the matrix is determined based on the relationships indicated by the elements in the matrix and first texts corresponding to rows in the matrix.

The first texts are determined as training samples in response to the first dispersion of the matrix being greater than a first threshold and the first concentration of the matrix being greater than a second threshold.

An embodiment of the disclosure provides an electronic device, and the electronic device includes a memory and a processor.

The memory is configured to store computer-executable instructions runnable on the processor.

The processor is configured to:
construct a matrix, wherein each of elements in the matrix indicates a relationship between a first text corresponding to a row to which the element belongs and a second text corresponding to a column to which the element belongs;
determine a first dispersion of the matrix based on the relationships indicated by the elements in the matrix;
determine a first concentration of the matrix based on the relationships indicated by the elements in the matrix and first texts corresponding to rows in the matrix; and
determine the first texts as training samples in response to the first dispersion of the matrix being greater than a first threshold and the first concentration of the matrix being greater than a second threshold.

An embodiment of the disclosure provides a non-transitory computer-readable storage medium having stored thereon computer-executable instructions that, when executed by a processor, implement a method for data processing, and the method includes the following operations.

A matrix is constructed. Each of elements in the matrix indicates a relationship between a first text corresponding to a row to which the element belongs and a second text corresponding to a column to which the element belongs.

A first dispersion of the matrix is determined based on the relationships indicated by the elements in the matrix.

A first concentration of the matrix is determined based on the relationships indicated by the elements in the matrix and first texts corresponding to rows in the matrix.

The first texts are determined as training samples in response to the first dispersion of the matrix being greater than a first threshold and the first concentration of the matrix being greater than a second threshold.

### BRIEF DESCRIPTION OF THE DRAWINGS

FIG. 1 is a schematic diagram of architecture of a text data processing system according to an embodiment of the disclosure.

FIG. 2 is a structural schematic diagram of an electronic device for determining a target training set according to an embodiment of the disclosure.

FIG. 3 is a first schematic flowchart of a method for data processing according to an embodiment of the disclosure.

FIG. 4 is a second schematic flowchart of the method for data processing according to an embodiment of the disclosure.

FIG. 5 is a structural schematic diagram of a target classification model according to an embodiment of the disclosure.

### DETAILED DESCRIPTION

In order to make the purposes, technical solutions and advantages of the disclosure clearer, the disclosure will be described in further detail below with reference to the accompanying drawings. The described embodiments should not be regarded as a limitation of the disclosure. All other embodiments obtained by those of ordinary skilled in the art without making any creative effort fall within the scope of protection of the disclosure.

In the following description, reference is made to “some embodiments”, which describes a subset of all possible embodiments, but it is to be understood that “some embodiments” may be a same subset or different subsets of all possible embodiments, and may be combined with each other without conflict.

In the following description, reference to the terms “first, second, and third” is merely to distinguish similar objects and do not represent a specific ordering for the objects. It is to be understood that “first, second, and third” in a specific order or sequence may be interchanged where permitted, to enable the embodiments of the disclosure described herein to be implemented in an order other than that illustrated or described herein.

Unless otherwise defined, all technical and scientific terms used herein have the same meaning as commonly understood by those skilled in the art to which the disclosure belongs. The terms used herein are intended solely for the purpose of describing the embodiments of the disclosure, and are not intended to limit the disclosure.

Before providing a further detailed descriptions of the embodiments of the disclosure, the nouns and terms involved in the embodiments of the disclosure will be described. The nouns and terms involved in the embodiments of the disclosure are applicable to the following explanations.
1) Text (Training sample): it is a basic concept in the field of machine learning and statistical learning. When constructing and training a machine learning model, the text refers to a specific data instance used to enable the model to learn data features and establish a prediction model. Each text typically comprises input features and corresponding output labels or target values. A training sample usually comprises input features and output labels. The input features are feature vectors that describe data instances. These features are extracted from a dataset and are used to enable the model to understand the data attributes. For example, when training a model to classify cats in pictures, each text may include the picture itself and its corresponding labels for cat and non-cat. The output label is an expected output of the text, which is used to guide model learning. The label may be a classification label in a classification problem (such as a cat or a dog), a numerical value in a regression problem (such as a housing price), or any other type of information, depending on the nature of the problem being solved. In a supervised learning, the texts are examples of known classifications or values, and the model predicts the classifications or values of unknown data by learning these examples. The choice and quality of texts directly affect the performance of the model. Therefore, when preparing training data, it is usually necessary to collect a large number of representative samples and improve the quality of the data through preprocessing, to eliminate noise and irrelevant information. The correct selection and application of texts are crucial for the generalization ability of the model, which refers to the prediction ability of the model for new data. A good text set should be large enough, representative, and cover all possible cases, so that the model can accurately predict unknown data after training.
2) Matrix: it is a rectangular array arranged with numbers (or more generally, mathematical objects). A matrix is typically denoted by an uppercase letter, while each element within the matrix is denoted by the corresponding lowercase letter and subscript. The matrix has rows and columns, and the concepts of row vectors and column vectors are proposed relative to the rows and columns of the matrix, respectively. The number of rows and columns of a matrix is referred to as its row rank and column rank, respectively.
3) Row vector: it is a matrix with only one row. The row vector is usually used to represent the direction and length of a vector, which may be represented as an arrow in geometric space. In the field of machine learning and other fields, a row vector may represent multiple features of a data point. Each element may be the numerical value of a feature. When a row vector is transposed, it becomes a column vector, and vice versa.
4) Column vector: it is a matrix with only one column. The column vector may also represent the direction and length of a vector, but in a different dimension. In practical applications, such as feature vectors in machine learning, a column vector is often used to represent multiple features of a data point, and each element denotes a numerical value of a respective feature. The column vector and the row vector have a conceptual perpendicular relationship. The row vectors of a matrix constitute its column space, while the column vectors constitute its row space.
5) Text set (Training dataset): it is a set of data used to train a model in machine learning and statistical learning. The set comprises a large number of labeled data samples, each sample includes input data and corresponding output label or target value. In the process of machine learning, the text set is used to enable the model to learn the relationship between the input data and the output label. By continuously adjusting the internal parameters of the model, it enables the model to make accurate predictions on the text set. Consequently, the model can make predictions on new data after training process is completed. The quality of text set significantly impacts the performance of model trained based on the text set. A high-quality text set should have the following characteristics. Representativeness: the text set should be able to represent the data distribution of the actual problem, thereby ensuring that the model has good generalization ability in practical applications. Large enough: the larger the text set, the more comprehensive the information the model learns, thereby improving the accuracy and stability of the model in practical applications. Diversity: the text set should include many different types of data, so that the model can learn a variety of complex situations. Less noise: the text set should minimize noise and irrelevant information to improve the training effect of the model. In practical applications, it often requires substantial time and effort to collect, organize, and pre-process text set to ensure the performance of the model.

In the implementation process of the embodiments of the disclosure, the applicant has identified the following issues in the related art.

In the related art, for text data processing, it is typically performed by evaluating each text individually. When each text meets the evaluation condition, data processing is performed based on the texts. However, since evaluating texts individually cannot accurately account for the influence between different texts, it results in relatively poor data processing performance.

Embodiments of the disclosure provide a method and device for data processing, an electronic device, a computer-readable storage medium, and a computer program product, which can effectively improve the training set quality of a target training set. An exemplary application of the text data processing system according to an embodiment of the disclosure will be described below.

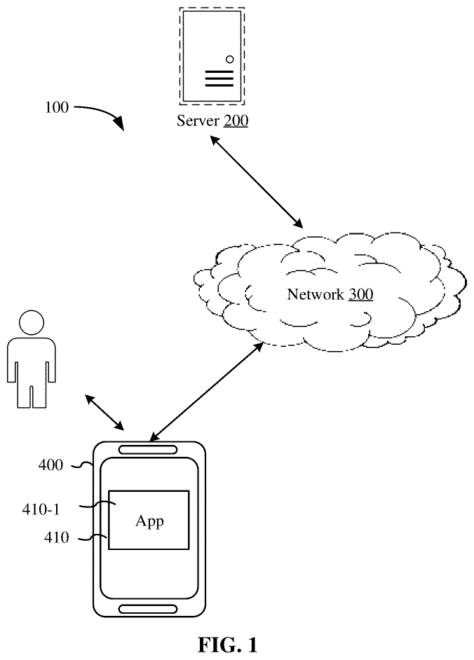

Referring to FIG. 1, FIG. 1 is a schematic diagram of architecture of the text data processing system 100 according to an embodiment of the disclosure. A terminal (exemplarily illustrating a terminal 400) connects to a server 200 via a network 300. The network 300 may be a wide area network or a local area network, or a combination thereof.

The terminal 400 is configured to enable a user to access the client 410, so as to display a test script on a graphical interface 410-1 (exemplarily illustrating a graphical interface 410-1). The terminal 400 and the server 200 are interconnected via a wired or wireless network.

In some embodiments, the server 200 may be an independent physical server, a server cluster or a business system composed of multiple physical servers, or a cloud server that provides basic cloud computing services such as cloud service, cloud database, cloud computing, cloud function, cloud storage, network service, cloud communication, middleware service, domain name service, security service, content delivery network (CDN), and big data and artificial intelligence platform. The terminal 400 may be a smartphone, a tablet computer, a notebook computer, a desktop computer, a smart speaker, a smart TV, a smart watch, an in-vehicle terminal, or the like, but it is not limited thereto. The electronic device according to an embodiment of the disclosure may be implemented as a terminal or a server. The terminal and the server may be directly or indirectly connected via wired or wireless communication manner, which is not limited in the embodiments of the disclosure.

In some embodiments, the server 200 constructs a matrix of texts, determines a first dispersion of the matrix based on the relationships indicated by elements in the matrix, determines a first concentration of the matrix based on the relationships indicated by elements in the matrix and the first texts, and sends the first concentration and the first dispersion to the terminal 400. If the terminal 400 determines that the first dispersion is greater than a first threshold and the first concentration is greater than a second threshold, the terminal 400 determines the first texts as training samples.

In other embodiments, the terminal 400 constructs a matrix of texts, determines a first dispersion of the matrix based on the relationships indicated by elements in the matrix, determines a first concentration of the matrix based on the relationships indicated by elements in the matrix and the first texts, and sends the first concentration and the first dispersion to the server 200. If the server 200 determines that the first dispersion is greater than a first threshold and the first concentration is greater than a second threshold, the server 200 determines the first texts as training samples.

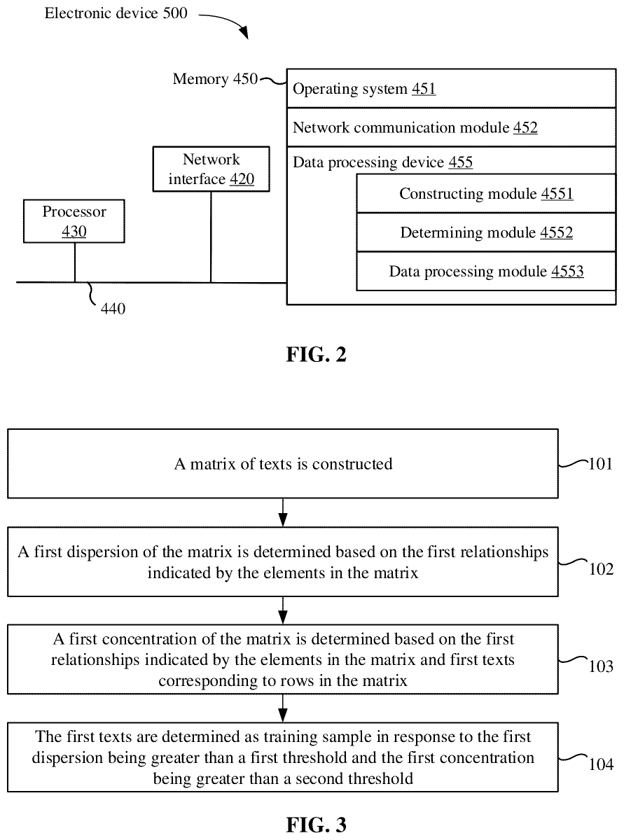

Referring to FIG. 2, FIG. 2 is a structural schematic diagram of an electronic device 500 for determining a target training set according to an embodiment of the disclosure. The electronic device 500 illustrated in FIG. 2 may be the server 200 or the terminal 400 in FIG. 1. The electronic device 500 illustrated in FIG. 2 includes: at least one processor 430, a memory 450, and at least one network interface 420. Various components in the electronic device 500 are coupled together via a bus system 440. It will be appreciated that the bus system 440 is configured to implement the connection and communication between these components. In addition to a data bus, the bus system 440 further includes a power bus, a control bus, and a status signal bus. However, for clarity of illustration, various buses are labeled as the bus system 440 in FIG. 2.

The processor 430 may be an integrated circuit chip with signal processing capabilities, such as a general-purpose processor, a digital signal processor (DSP), or other programmable logic devices, a discrete gate or transistor logic device, a discrete hardware component, or the like. Among these, the general-purpose processor may be a microprocessor or any conventional processor, or the like.

The memory 450 may be removable, non-removable, or a combination thereof. Exemplary hardware devices include a solid state memory, a hard disk drive, an optical disk drive, or the like. The memory 450 optionally includes one or more storage devices that are physically located remotely from the processor 430.

The memory 450 includes a volatile memory or a non-volatile memory, or may include both a volatile memory and a non-volatile memory. The non-volatile memory may be a read only memory (ROM), and the volatile memory may be a random access memory (RAM). The memory 450 described in embodiments of the disclosure is intended to include any suitable types of memories.

In some embodiments, the memory 450 is capable of storing data to support various operations, and examples of the data include programs, modules, and data structures, or subsets or supersets thereof, as illustrated below.

An operating system 451 includes system programs designed to handle various basic system services and execute hardware-related tasks, such as in a framework layer, a core library layer, a driver layer, and the like, enabling the implementation of diverse basic services and the processing of hardware-based tasks.

A network communication module 452 is configured to access other electronic devices via one or more (wired or wireless) network interfaces 420. Exemplary network interfaces 420 include Bluetooth, wireless fidelity (WiFi), and universal serial bus (USB), etc.

In some embodiments, the device for data processing according to an embodiment of the disclosure may be implemented in software. FIG. 2 illustrates a data processing device 455 stored in the memory 450, which may be the software in the form of programs and plug-ins. The data processing device 455 includes a constructing module 4551, a determining module 4552, and a data processing module 4553. These modules are logical, and as such, they can be arbitrarily combined or further subdivided based on the functions implemented. The functions of the modules will be described hereinafter.

In other embodiments, the device for data processing according to an embodiment of the disclosure may be implemented in hardware. By way of example, the device for data processing according to an embodiment of the disclosure may be a processor in the form of a hardware decoding processor which is programmed to perform the method for data processing according to an embodiment of the disclosure. For example, the processor in the form of the hardware decoding processor may adopt one or more application specific integrated circuits (ASIC), a DSP, a programmable logic device (PLD), a complex programmable logic device (CPLD), a field programmable gate array (FPGA), or other electronic elements.

In some embodiments, the terminal or the server may implement the method for data processing according to an embodiment of the disclosure by running a computer program or computer-executable instructions. For example, the computer program may be a program native to an operating system (e.g., a dedicated script generation program) or a software module, such as a script generation module that may be embedded into any program (e.g., an instant messaging client, a photo gallery application, an electronic map client, a navigation client). Additionally, the computer program may be a native application (APP), that is, a program that needs to be installed in the operating system to run. In summary, the aforementioned computer program may be any form of application, module, or plug-in.

The data processing method according to embodiments of the disclosure will be described in conjunction with exemplary applications and implementations of the server or the terminal according to embodiments of the disclosure.

Referring to FIG. 3, which is a first schematic flowchart of a method for data processing according to an embodiment of the disclosure, an explanation will be provided in conjunction with operations 101 to 103 illustrated in FIG. 3. The method for data processing according to an embodiment of the disclosure may be implemented independently by a server or a terminal, or collaboratively by both a server and a terminal. The following explanation will take the scenario where the method is implemented independently by a server as an example.

In operation 101, a matrix of texts is constructed.

In some embodiments, the texts correspond one-to-one with row vectors of the matrix. Each of elements in the matrix indicates a relationship between a first text corresponding to a row to which the element belongs and a second text corresponding to a column to which the element belongs, and elements in a same row of the matrix correspond to a same first text.

In some embodiments, column vector of the matrix indicates whether the second text is in the first text, and different column vectors correspond to different second texts.

As an example, an example of a matrix is shown below, which is based on a dataset including 5 texts, and each sample may include different second texts.

$$[ \begin{matrix}1 & 0 & 1 & 0 \\ 0 & 1 & 1 & 0 \\ 1 & 0 & 0 & 1 \\ 0 & 0 & 1 & 1 \\ 1 & 1 & 1 & 1\end{matrix} ]$$

Following the above example, Table 1 below is the schematic table corresponding to the above matrix.

TABLE 1
Schematic table corresponding to the matrix

| Sample | Second | Second | Second | Second |
|---|---|---|---|---|
| Number | text A | text B | text C | text D |
| First text 1 | 1 | 0 | 1 | 0 |
| First text 2 | 0 | 1 | 1 | 0 |
| First text 3 | 1 | 0 | 0 | 1 |
| First text 4 | 0 | 0 | 1 | 1 |
| First text 5 | 1 | 1 | 1 | 1 |

Following the above example, in the above matrix, each row represents one first text, while each column represents one second text. In the matrix, element 1 represents that the first text includes the corresponding second text, while element 0 represents that the first text does not include the corresponding second text. For example: the first text 1 includes the second text A and the second text C, but does not include the second text B and the second text D; the first text 2 does not include the second text A and the second text D, but includes the second text B and the second text C; and so on until the first text 5.

In some embodiments, the above operation 101 may be implemented in the following manner. For each of the first texts, a row vector corresponding to the first text is determined based on the first text and the second texts. Row vectors corresponding to the first texts are concatenated to obtain the matrix.

Following the above example, the row vector corresponding to the first text 1 may be {1, 0, 1, 0}, the row vector corresponding to the first text 2 may be {0, 1, 1, 0}, the row vector corresponding to the first text 3 may be {1, 0, 0, 1}, the row vector corresponding to the first text 4 may be {0, 0, 1, 1}, and the row vector corresponding to the first text 5 may be {1, 1, 1, 1}. The row vectors corresponding to the first text 1, the first text 2, the first text 3, the first text 4 and the first text 5 are concatenated to obtain the matrix of an initial training set.

$$[ \begin{matrix}1 & 0 & 1 & 0 \\ 0 & 1 & 1 & 0 \\ 1 & 0 & 0 & 1 \\ 0 & 0 & 1 & 1 \\ 1 & 1 & 1 & 1\end{matrix} ]$$

In some embodiments, the above matrix is a rectangular array arranged with numbers (or more generally, mathematical objects). A matrix is typically denoted by an uppercase letter, while each element within the matrix is denoted by the corresponding lowercase letter and subscript. The matrix has rows and columns, and the concepts of row vectors and column vectors are proposed relative to the rows and columns of the matrix, respectively. The number of rows and columns of a matrix is referred to as its row rank and column rank, respectively.

In some embodiments, the operation that the row vector corresponding to the first text is determined based on the first text and the second texts may be implemented in the following manner. For each of the second texts, the second text is compared with the first text to obtain a comparison result. A value of an element corresponding to the second text is determined based on the comparison result. The values of the elements are concatenated to obtain the row vector corresponding to the first text.

In some embodiments, the comparison result described above indicates whether a first text includes a second text.

Following the above example, for the second text A, the second text A is compared with the first text 1 to obtain a comparison result of the second text A, and the comparison result of the second text A indicates that the first text 1 includes the second text A.

Following the above example, for the second text B, the second text B is compared with the first text 1 to obtain a comparison result of the second text B, and the comparison result of the second text B indicates that the first text 1 does not include the second text B.

In some embodiments, the operation that the matrix of the texts is constructed may be implemented in the following manner. A first text corresponding to each row of the matrix is compared with a second text corresponding to each column of the matrix to obtain multiple comparison results. Each of the multiple comparison results represents whether the first text includes the second text. Each of the multiple comparison results is taken as the relationship indicated by the respective element in the matrix.

In some embodiments, the relationship between the first text and the second text is represented by the corresponding element in the matrix. This relationship may be based on text content similarity, co-occurring words, or shared topic distributions in topic models, etc. For a first text corresponding to each row of the matrix and a second text corresponding to each column of the matrix, a certain comparison mechanism is used to determine whether a specific relationship exists between the first text and the second text.

As an example, the following is a specific example to describe how to construct a matrix of texts to represent the relationships between the texts and how to use these relationships as elements in the matrix. Assume that there are two text sets, in which set A includes texts a1, a2 and a3, and set B includes texts b1, b2 and b3. To construct a matrix based on the set A and the set B, each of elements in the matrix represents a relationship between a respective text in the set A and a respective text in the set B. Each text is preprocessed, such as performing tokenization, removing stop-words, etc. Assume the preprocessed results are as follows: text a1: [“word1”, “word2”, “word3” ]; text a2: [“word2”, “word3”, “word4” ]; text a3: [“word3”, “word5”, “word6” ]; text b1: [“word2”, “word7” ]; text b2: [“word3”, “word8” ]; text b3: [“word9”, “word10” ]. The comparison results are as follows: for a1 and b1, they have the common word “word2”, so the relationship between a1 and b1 is 1; for a1 and b2, they have the common word “word3”, so the relationship between a1 and b2 is 1; for a1 and b3, they have no common word, so the relationship between a1 and b3 is 0; for a2 and b1, they have the common word “word2”, so the relationship between a2 and b1 is 1; for a2 and b2, they have the common word “word3”, so the relationship between a2 and b2 is 1; for a2 and b3, they have no common word, so the relationship between a2 and b3 is 0; for a3 and b1, they have no common word, so the relationship between a3 and b1 is 0; for a3 and b2, they have the common word “word3”, so the relationship between a3 and b2 is 1; for a3 and b3: they have no common word, so the relationship between a3 and b3 is 0. The rows represent the texts in the set A and the columns represent the texts in the set B. Each element represents the relationship between the respective texts, where 1 represents that a relationship exists between the respective texts, and 0 represents that no relationship exists between the respective texts.

In some embodiments, in different application scenarios, the construction of the target training set may be different from the model training scheme, but the basic idea is similar. That is to say, by analyzing the features of the initial training set, a matrix is constructed, and the matrix is evaluated to meet specific training objectives. Different application scenarios will be described by examples below.

In some embodiments, in the application scenario of text classification, the initial training set is a set that includes a large amount of labeled text data, such as news articles, social media posts, etc. A matrix is a structure where each row represents a text, and column vectors represent different text features (such as word frequency, term frequency-inverse document frequency (TFIDF), sentence length, etc.). The second texts may be different classification labels, such as sports, entertainment, etc. The evaluation parameters may be a classification accuracy rate, a recall rate, an F1 score, and the like. The target training set is determined as follows: if the evaluation parameters of the matrix reach meet preset thresholds, the initial training set is determined as the target training set.

In some embodiments, in the application scenario of image recognition, the initial training set is a set that includes various labeled text data, and the text data in the initial training set may be obtained by performing text conversion on images, such as natural landscapes, animals, buildings, etc. Each row of the constructed matrix corresponds to one image sample, and the column vectors represent different features of the image (such as color histogram, edge detection features, feature vectors extracted via deep learning, etc.). The second texts may be different image classifications, such as a cat, a dog, a vehicle, or the like. The evaluation parameters may be an image recognition accuracy rate, a confusion matrix, and the like. The target training set is determined as follows: when the evaluation parameters of the matrix meet the performance requirements of the model, the initial training set is determined as the target training set.

In some embodiments, in the application scenario of speech recognition, the initial training set may be a set that includes labeled texts, such as words, sentences, etc., and the texts may be obtained by performing text conversion on speeches. Each row of the constructed matrix corresponds to one speech sample, and the column vectors represent features of the speech (such as Mel-frequency cepstral coefficients (MFCC), spectral features, etc.). The second texts may be different words or sentences in speech recognition. The evaluation parameters may be a recognition accuracy rate, a word error rate (WER), or the like. The target training set is determined as follows: if the evaluation parameters of the matrix achieve expected performance standards, the initial training set is determined as the target training set.

In some embodiments, in the application scenario of product recommendation, the initial training set may be a set that includes text data on the interactions between users and items, such as scoring, clicking, and purchasing, and the like. Each row of the constructed matrix represents one user or one item, and the column vectors represent features of the user or features of the item. The second text may be an interest preference of the user or an attribute label of the item. The evaluation parameters may be an accuracy rate, a recall rate, a coverage rate, and the like. The target training set is determined as follows: when the evaluation parameters of the matrix indicate that the model has good recommendation performance, the initial training set is determined as the target training set.

In some embodiments, the construction of the matrix and the determination of the evaluation parameters may be implemented by using a server based on a graphics processing unit (GPU). The server is configured as follows. CPU: a multi-core processor. GPU: with high-performance computing capabilities. Memory: sufficiently large memory capacity to store matrices and intermediate calculation results. Storage: a fast solid-state drive (SSD) to minimize data read/write time. Through a parallel computing framework, compute-intensive tasks are executed on the GPU. Utilizing GPU-accelerated natural language processing libraries (e.g., cuDNN, cuText), preprocessing and feature extraction are performed on M texts. The feature vectors of each sample are stored in the GPU memory to construct a matrix. The correlations between elements in the matrix and the second texts are calculated by using the parallel computing capabilities of the GPU. The evaluation parameters are calculated, such as sparsity of a matrix, distribution statistics of element values of the matrix, etc. The evaluation parameters are transmitted from the GPU to the CPU, and the CPU is used to perform logical judgment to determine whether a preset evaluation indicator is met. If the condition is met, the initial training set is labeled as the target training set. Due to the significant speed advantage of GPU over CPU in processing large-scale parallel computational tasks, the matrix can be rapidly constructed and the evaluation parameters can be rapidly calculated. Taking advantage of the high parallelism of GPU, computing resources can be used more efficiently, thereby reducing dependency on CPU and lowering overall energy consumption. For large-scale datasets, GPU utilization enables processing of more data samples, thereby enhancing the generalization capability of the model. Although the initial investment in high-performance hardware is substantial, its enhanced computational efficiency can reduce operational costs, particularly when processing a large amount of data. By enabling more efficient computations, it facilitates the precise construction of the matrix and the evaluation parameter calculation, thereby improving both the training quality and accuracy of the model.

In this way, by constructing the matrix of texts, each of elements in the matrix indicates a relationship. A first dispersion of the matrix is determined based on the relationships indicated by the elements in the matrix. A first concentration of the matrix is determined based on the relationships indicated by the elements in the matrix and the first texts. Consequently, substantial memory space is required to store elements in the matrix and compute intermediate results, prompting hardware devices to optimize memory allocation strategies and enhance memory utilization efficiency. During the matrix computation, it is essential to rationally allocate computing resources of CPU and GPU. The implementation of the technical solution drives hardware devices to enhance task scheduling capabilities, ensuring maximum utilization of computing resources. The computational tasks of the technical solution are suitable for parallelization, which promotes hardware devices to optimize parallel computing architectures-such as increasing the number of GPU cores or improving CPU parallel processing capabilities to better accommodate computational requirements.

In some embodiments, a field programmable gate array (FPGA)-based solution can be employed to implement the matrix construction of texts and the determination of evaluation parameters. This involves designing an FPGA circuit including a digital signal processor (DSP) module for processing texts, a parallel processing unit for matrix operations, and a logic control unit for controlling flow and data flow. A special text preprocessing module is implemented on an FPGA, and this module includes tokenization, stop-word removal, part-of-speech tagging and other functions. A feature extraction module is designed to calculate text features in parallel on the FPGA, such as word frequency, TFIDF and so on. A matrix operation module is created to construct a matrix on the FPGA, and each row of the matrix represents a feature vector of a text. A correlation calculation module is implemented, and this module may calculate the correlations between elements in the matrix and the second texts in parallel. An evaluation parameter calculation module is designed to calculate the evaluation parameters of the matrix, such as average similarity and variance. A logic control unit is implemented on the FPGA. This unit compares the evaluation parameter with the preset evaluation indicator, and makes a decision on whether to determine the initial training set as the target training set.

In some embodiments, a large amount of data may be processed by constructing a matrix of texts and analyzing the relationships in the matrix. For hardware devices, this means that they need to have high data throughput and processing speed, thereby promoting the performance improvement of hardware devices. To support the construction of matrix of texts and the determination of evaluation parameters, hardware devices need to optimize the allocation of memory and computing resources to efficiently store and process matrix data, which helps to improve the overall efficiency and performance of hardware. The construction of matrix and the calculation of parameters involved are typical tasks that may be processed in parallel. Hardware devices require robust parallel computing capabilities to support this process, thereby promoting the design and optimization of hardware in parallel processing. The storage demands of a matrix of texts may be exceptionally large, necessitating efficient storage solutions on hardware devices, including high-speed read/write capabilities and sufficient storage capacity to meet the processing demands of large data volumes. The data processing involved is dynamic, and the calculations of dispersion and concentration may vary depending on different text data. Hardware devices need to adapt to such dynamic loads, ensuring high-efficiency performance under varying operational loads. When processing a matrix of texts and calculating evaluation parameters, hardware devices need to maintain stability and reliability to ensure the accuracy and consistency of data processing results. Therefore, it enhances the data processing capabilities of hardware devices, optimizes resource allocation, strengthens parallel computing capabilities, improves storage efficiency, adapts to dynamic load changes, reduces power consumption and demands, increases stability and reliability, and facilitates ease of maintenance and upgrades.

As such, FPGA allow for hardware customization tailored to specific applications, thereby achieving highly optimized processing flows. Due to its ability to process data in parallel, FPGA can achieve lower processing latency compared to CPU-based solution or GPU-based solution. When performing specific tasks, FPGA generally exhibits a higher energy efficiency ratio than general-purpose processors. By increasing the scale of FPGAs or integrating multiple FPGAs, larger-scale datasets can be processed. As a hardware solution, FPGA can provide a higher level of data security and tamper resistance compared to a software solution.

In this way, by determining the row vector of each text and concatenating them into a matrix, a structured data representation may be obtained, which makes the data easy to be processes and analyzed. Each column of the matrix represents one feature (one second text), which makes each feature clearly identifiable, facilitating the algorithm to understand and extract the relationships between features. The form of the matrix allows data to be processed using matrix operations, which are typically highly optimized in numerical computing libraries, enabling efficient handling of large-scale text data. The matrix provides an intuitive tool for analyzing the distribution of texts. By observing the matrix, one can quickly recognize which samples include a specific second text, which second texts are more common, and the similarity between samples, and the like. When matrices are used to train a machine learning model, the model can more easily identify and learn patterns and regularities included in samples. This contributes to enhancing the performance of the model, such as classification accuracy or prediction capability.

In operation 102, a first dispersion of the matrix is determined based on the relationships indicated by the elements in the matrix.

In some embodiments, the operation that the first dispersion of the matrix is determined based on the relationships indicated by the elements in the matrix may be implemented in the following manner. For each of elements in the matrix, a second dispersion of the element is determined based on a relationship indicated by the element and a relationship indicated by an adjacent element of the element. A third dispersion of the matrix is determined based on the determined second dispersions. The first dispersion of the matrix is determined based on the third dispersion and a preset value of the relationships.

In some embodiments, the first dispersion of the matrix is the degree of dispersion of all element values in the matrix. The first dispersion may be used to measure the uniformity or difference of the distribution of the first texts across the second texts. For each element in the matrix, a second dispersion of the element is calculated. The second dispersion is determined based on the value of the element and the value of an adjacent element of the element.

In some embodiments, the adjacent element includes a row-adjacent element and a column-adjacent element. The operation that the second dispersion of the element is determined based on the relationship indicated by the element and the relationship indicated by the adjacent element of the element may be implemented in the following manner. The relationship indicated by the element is compared with a relationship indicated by the row-adjacent element to obtain a first comparison result. The first comparison result represents whether the relationship indicated by the element is identical to the relationship indicated by the row-adjacent element. The relationship indicated by the element is compared with a relationship indicated by the column-adjacent element to obtain a second comparison result. The second comparison result represents whether the relationship indicated by the element is identical to the relationship indicated by the column-adjacent element. The second dispersion of the element is determined based on the first comparison result and the second comparison result.

In some embodiments, the operation that the second dispersion of the element is determined based on the first comparison result and the second comparison result may be implemented in the following manner. A first row-indication value is determined in response to the first comparison result representing that the relationship indicated by the element is identical to the relationship indicated by the row-adjacent element. A second row-indication value is determined in response to the first comparison result representing that the relationship indicated by the element is not identical to the relationship indicated by the row-adjacent element. A first column-indication value is determined in response to the second comparison result representing that the relationship indicated by the element is identical to the relationship indicated by the column-adjacent element. A second column-indication value is determined in response to the second comparison result representing that the relationship indicated by the element is not identical to the relationship indicated by the column-adjacent element. The second dispersion is determined based on the first row-indication value, the second row-indication value, the first column-indication value and the second column-indication value.

As an example, if the relationship of an element is identical to the relationship of an adjacent element in the same row, this state is referred to as “consistent”, and an indication value (which may be 1, 0, or another label) is determined to represent this consistency. If the relationship of an element is not identical to the relationship of an adjacent element in the same row, this state is referred to as “inconsistent”, and another indication value is determined to represent this inconsistency. If the relationship of an element is identical to the relationship of an adjacent element in the same column, an indication value is also determined to represent this consistency. The indication value reflects the degree of consistency of the column in the relationship. If the relationship of an element is not identical to the relationship of an adjacent element in the same column, a different indication value is determined to represent this inconsistency. The difference between the row-indication value and the column-indication value is calculated. For example, if the row-indication value is 1 (consistent) and the column-indication value is 0 (inconsistent), the difference is 1. The larger the difference, the higher the dispersion. The indication values are combined into one pattern, such as “1001” or “0110”, and the second dispersion is determined based on the relationship between the predefined pattern and the dispersion.

As an example, the expression of the second dispersion of an element x_{i,j} is as follows:

$$t = {I}_{1} ( {x}_{i , j + 1} - {x}_{i , j} ) + {I}_{2} ( {x}_{i + 1 , j} - {x}_{i , j} ) \qquad ( 1 )$$

where x_{i,j} represents an element in i-th row and j-th column of the matrix, x_{i,j+1} represents an element in i-th row and (j+1)-th column of the matrix, x_{i+1,j} represents an element in (i+1)-th row and j-th column of the matrix, I₁(x_{i,j+1}−x_{i,j}) is a first indication function (i.e. a first comparison result), and I₂(x_{i+1,j}−x_{i,j}) is a second indication function (i.e. a second comparison result).

Following the above example, the expression of the above first indication function I₁(x_{i,j+1}−x_{i,j}) (i.e. the first comparison result) is as follows:

$${I}_{1} ( {x}_{i , j + 1} - {x}_{i , j} ) = \{ \begin{matrix}0 , {x}_{i , j + 1} = {x}_{i , j} or j + 1 > n \\ 1 , {x}_{i , j + 1} \neq {x}_{i , j}\end{matrix} \qquad ( 2 )$$

where when x_{i,j+1}≠x_{i,j}, it represents that two adjacent elements x_{i,j+1} and x_{i,j} in the same row are different, at this time, I₁(x_{i,j+1}−x_{i,j})=1. When x_{i,j+1}=x_{i,j}, it represents that two adjacent elements x_{i,j+1} and x_{i,j} in the same row are identical, at this time, I₁(x_{i,j+1}−x_{i,j})=0. When j+1>n, it exceeds the range of the matrix (because the matrix has a total of n columns), at this time, I₁(x_{i,j+1}−x_{i,j})=0.

Following the above example, the expression of the above second indication function I₂(x_{i+1,j}−x_{i,j}) (i.e. the second comparison result) is as follows:

$${I}_{2} ( {x}_{i + 1 , j} - {x}_{i , j} ) = \{ \begin{matrix}0 , {x}_{i + 1 , j} = {x}_{i , j} or i + 1 > m \\ 1 , {x}_{i + 1 , j} \neq {x}_{i , j}\end{matrix} \qquad ( 3 )$$

where when x_{i+1,j}≠x_{i,j}, it represents that two adjacent elements xᵢ₊₁ and x_{i,j} in the same column are different, at this time, I₂(x_{i+1,j}−x_{i,j})=1. When x_{i+1,j}=x_{i,j}, it represents that two adjacent elements x_{i+1,j} and x_{i,j} in the same column are identical, at this time, I₂(x_{i+1,j}−x_{i,j}=0. When i+1>m, it exceeds the range of the matrix (because the matrix has a total of m rows), at this time, I₂(x_{i+1,j}−x_{i,j})=0.

As an example, the expression of the first dispersion of the above matrix is as follows:

$$ω = \frac{T}{k} = \frac{{\sum }_{i = 1}^{m} {\sum }_{j = 1}^{n} {I}_{1} ( {x}_{i , j + 1} - {x}_{i , j} ) + {I}_{2} ( {x}_{i + 1 , j} - {x}_{i , j} )}{k} \qquad ( 4 )$$

where ω represents the first dispersion of the matrix, T represents the third dispersion, k represents a preset value of the relationships, I₁(x_{i,j+1}−x_{i,j})+I₂(x_{i+1,j}−x_{i,j}) represents the second dispersion of the element x_{i,j}, i represents the row number of the matrix and j represents the column number of the matrix.

Following the above example, the expression of the reference value of the above element is as follows:

$${I}_{3} ( {x}_{i , j} ) = \{ \begin{matrix}0 , & {x}_{i , j} \neq 0 \\ 1 , & {x}_{i , j} = 0\end{matrix} \qquad ( 5 )$$

where I₃(x_{i,j}) represents the reference value of the element x_{i,j}. When x_{i,j}=0, I₃(x_{i,j})=1. When x_{i,j}≠0, I₃(x_{i,j})=0.

Following the above example, the expression of the preset value of the above relationships is as follows:

$$k = {\sum }_{i = 1}^{m} {\sum }_{j = 1}^{n} {I}_{3} ( {x}_{i , j} ) \qquad ( 6 )$$

where k represents the preset value of the relationships, and I₃(x_{i,j}) represents the reference value of the element x_{i,j}.

Following the above example, the numerator

$${\sum }_{i = 1}^{m} {\sum }_{j = 1}^{n} {I}_{1} ( {x}_{i , j + 1} - {x}_{i , j} ) + {I}_{2} ( {x}_{i + 1 , j} - {x}_{i , j} )$$

represents that for each element x_{i,j} in the matrix A, the number of adjacent elements that are different from the element is calculated, which measures the degree of dispersion or disorder of elements in the matrix A, and a larger value represents a higher degree of dispersion or disorder of elements in the matrix. However, relying solely on the numerator may lead to some misjudgments. For example, for matrix

$$[ \begin{matrix}0 & 1 & 2 \\ 0 & 3 & 0\end{matrix} ]$$

and matrix

$$[ \begin{matrix}1 & 2 & 3 \\ 0 & 0 & 3\end{matrix} ] ,$$

both yield a numerator value of 6, but it is obvious that the degrees of sparsity of the two matrices are not consistent. The denominator k represents the number of zero elements in the matrix, and a smaller k represents that the composition of elements in the matrix is more complex. By combining the numerator with the denominator, this approach can address both the misjudgment of the numerator in this solution and the drawback of existing method that relies solely on the number of zero elements in the matrix to determine the sparsity of the matrix. The calculation method for the first dispersion ω proposed in this solution follows the principle: a larger numerator (indicating greater degree of dispersion of the elements) and a smaller denominator (indicating fewer zero elements in the matrix) result in a higher value of the first dispersion ω. The superior the first dispersion of the data, the lower the sparsity of the matrix A.

As such, by calculating the second dispersion of each element in the matrix, a more detailed analysis of the dataset is enabled. This approach captures local variability, which may help reveal the subtle relationships between sample features. Considering the relationships between adjacent elements can improve the ability to identify local patterns, which may help to improve the accuracy of subsequent text data processing. All the second dispersions are summed to obtain a third dispersion, which provides a global metric for evaluating the variability of the whole matrix. By performing the summation, a single indicator reflecting the variability of the whole matrix may be obtained, thereby facilitating a global understanding of the characteristics of the dataset. The introduction of the reference value standardizes the calculation of the first dispersion, helping to eliminate the influence of different element values, and rendering the first dispersion indicator more stable and consistent. The third dispersion is divided by the preset value of the relationships to obtain the first dispersion of the matrix, which is a normalization process. Through normalization, the resulting first dispersion indicator is independent of the magnitude of the original data values, making the indicator more universally applicable and comparable. This approach facilitates more accurate capture and quantification of data variability, providing additional means for data analysis and visualization while aiding in a better understanding of the inherent characteristics of the initial dataset.

In operation 103, a first concentration of the matrix is determined based on the relationships indicated by the elements in the matrix and the first texts corresponding to rows in the matrix.

In some embodiments, the operation that the first concentration of the matrix is determined based on the relationships indicated by the elements in the matrix and the first texts corresponding to rows in the matrix may be implemented in the following manner. A concentration of each of rows of the matrix is determined based on the relationships indicated by elements in the row of the matrix. A second concentration of the matrix is determined based on the concentrations of all rows of the matrix (for example, the sum of the concentrations of the rows of the matrix is determined as the second concentration of the matrix). A total number of elements (which are a subset of the elements in the matrix, and each of these elements indicates a relationship that the second text is in the first text) is obtained. The first concentration of the matrix is obtained based on the second concentration and the total number (dividing the second concentration by the total number).

In some embodiments, each row in the matrix is analyzed to determine the concentration of the row. The concentration of the row may be an indicator that measures the degree of concentration or repetition of elements in a row vector. By summing the concentrations of all rows, the resulting summation is determined as the second concentration of the matrix. The second concentration may be an indicator that measures the concentration level of all rows of the entire matrix. The normalized second concentration indicator is easier to interpret as it provides a dimensionless value, enabling comparisons of the degrees of concentration across different matrices or datasets.

In some embodiments, the operation that the concentration of each of rows of the matrix is determined based on the relationships indicated by elements in the row of the matrix may be implemented in the following manner. For the respective relationship indicated by each element in each row of the matrix, in response to the relationship indicating that the second text corresponding to a column to which the element belongs is in the first text corresponding to a row to which the element belongs, an indication value of the element is determined based on a value of the element. A concentration of the element is determined based on the indication value of the element and the number of occurrences of the element in the row. The concentration of each row is determined based on the concentrations of all elements in the row.

In some embodiments, if an element in the matrix has a value of 1 (or any other value indicating “existence of a relationship”), it means that the second text corresponding to the column to which the element belongs is in the first text corresponding to the row to which the element belongs. In other words, the two text are related at some levels. For each element that displays the indicated relationship (i.e., the element with a value of 1), an indication value is assigned to the element. The indication value may be 1 or another flag that represents the special significance of the element within the matrix. If an element has a value of 0 (or any value indicating “inexistence of a relationship”), no indication value is typically assigned, or a default value is assigned.

In some embodiments, the operation that the indication value of the element is determined based on the value of the element may be implemented in the following manner. If the value of the element is greater than 1, the value of the element is determined as the indication value of the element. If an absolute value of the value of the element is less than 1, the indication value of the element is determined based on the absolute value of the value of the element and a constant. If the value of the element is less than −1, an absolute value of the value of the element is determined as the indication value of the element.

In some embodiments, if the value of the element is greater than 1, it typically indicates an extremely strong relationship between the two texts. In this case, the value of the element itself is used as the indication value, as it sufficiently represents a significant relationship between the texts. If the absolute value of the element is less than 1, it indicates a weak or moderate relationship between the two texts. In this case, the indication value of the element is not directly the value of the element; instead, it is determined based on the absolute value of the value of the element and a certain constant. The constant may be a threshold that is used to adjust the calculation manner of the indication value. For example, if the constant is 0.5, the indication value is obtained by multiplying the value of the element by this constant, or employing other constant-based calculation manners. If the value of the element is less than −1, it may indicate a negative correlation or an incompatible relationship between the two texts. In this case, the absolute value of the value of the element is used as the indication value, disregarding its negative sign, since the indication value is typically used to represent the strength of the relationship rather than its direction.

As an example, the expression of a concentration of a row in the matrix is as follows:

$${w}_{i} = \sqrt[{a}_{i}]{{\prod }_{j = 1}^{{b}_{i}} {c}_{i , j} {log}_{2} f ( {y}_{i , , j} )} \qquad ( 7 )$$

where Wᵢ represents the concentration of the row of the row vector of the i-th row in the matrix, aᵢ represents the number of non-zero elements in the row vector of the i-th row in the matrix, bᵢ represents the number of elements of different values among the non-zero elements in the row vector of the i-th row in the matrix, y_{i,j} represents the element of the j-th different value in the non-zero elements of the i-th row, f(y_{i,j}) is the step function, that is, the indication value of the element, and c_{i,j} log₂ f(y_{i,j}) represents the concentration of the element.

As an example, the expression of the above step function, that is, the indication value f(y_{i,j}) of the element is as follows:

$$f ( {y}_{i , j} ) = \{ \begin{matrix}{y}_{i , j} , {y}_{i , j} \geq 1 \\ \vert {y}_{i , j} \vert + 1 , - 1 < {y}_{i , j} < 1 \\ \vert {y}_{i , j} \vert , {y}_{i , j} \leq - 1\end{matrix} \qquad ( 8 )$$

where f(y_{i,j}) represents the step function, and y_{i,j} represents the element of the j-th different value in the non-zero elements of the i-th row.

As an example, the expression of the above first dispersion is as follows:

$$γ = \frac{{\sum }_{i = 1}^{m} \sqrt[{a}_{i}]{{\prod }_{j = 1}^{{b}_{i}} {c}_{i , j} {log}_{2} f ( {y}_{i , j} )}}{{\sum }_{i = 1}^{m} {a}_{i}} \qquad ( 9 )$$

where γ represents the first concentration,

$${\sum }_{i = 1}^{m} \sqrt[{a}_{i}]{{\prod }_{j = 1}^{{b}_{i}} {c}_{i , j} {log}_{2} f ( {y}_{i , j} )}$$

represents a second concentration of the matrix; and

$${\sum }_{i = 1}^{m} {a}_{i}$$

represents a total number of elements, each of these elements indicates a relationship that the second text is in the first text.

Following the above example,

$$\sqrt[{a}_{i}]{{\prod }_{j = 1}^{{b}_{i}} {c}_{i , j} {log}_{2} f ( {y}_{i , j} )}$$

in the numerator represents the concentration trend of non-zero elements of the i-th row, and f(y_{i,j}) is the step function. When y_{i,j}>1, f(y_{i,j})=y_{i,j}, at this time, log₂ f(y_{i,j})>0. The purpose of using log₂ f(y_{i,j}) is to reduce the influence of the extreme value on the concentration trend of non-zero elements (for example, log₂ 4=2, log₂ 64=6. Suppose 64 represents an extreme value relative to 4, the difference between the two elements before processing is 60, while after processing, the difference between the two elements is 4). When −1<y_{i,j}<1, f(y_{i,j})=|y_{i,j}|+1. The reason for this design is that, when −1<y_{i,j}<1, f(y_{i,j}) is negative and may potentially be a significantly large negative value, which will cause log₂ f(y_{i,j}) to deviate severely from its actual magnitude |y_{i,j}|. Therefore, at this time, f(y_{i,j})=|y_{i,j}|+1, which may ensure that log₂ f(y_{i,j}) is positive and does not deviate from its actual magnitude |y_{i,j}|. When y_{i,j}≤−1, f(y_{i,j})=|y_{i,j}|, because the value of f(y_{i,j}) in log₂ f(y_{i,j}) cannot be less than 0, the |y_{i,j}| is taken, which essentially equivalent to the case that: when y_{i,j}≥1, f(y_{i,j})=y_{i,j}. c_{i,j} represents the number of occurrences of y_{i,j} in the i-th row. The role of c_{i,j} is equivalent to assigning a corresponding weight to each of the different non-zero elements y_{i,j}. The reason for this is that the extreme value occurs extremely infrequently, whereas the non-extreme value occurs more frequently. In this way, by adding the corresponding weight to each non-zero element, the number of occurrences of the extreme value is effectively reduced, thereby reducing the influence of the extreme value on the concentration trend of non-zero elements. Π( ) represents the consecutive multiplication operation, and subsequently taking square root is to reduce potential large differences between different rows. The denominator

$${\sum }_{i = 1}^{m} {a}_{i}$$

represents the number of all non-zero elements in the matrix. By dividing the numerator by the denominator, the concentration trend γ of all non-zero elements is obtained. γ effectively avoids the influence of the extreme value (deviating from the normal value) in the existing method, and the concentration trend γ is used to detect the sparsity magnitude based on the magnitude of deviation of the element value from zero. The larger the concentration trend γ for element values in the matrix A, the smaller the sparsity of the matrix A.

In this way, calculating the concentration of each row can reveal the distribution characteristics of the values of the elements in the row vector, which is helpful to understand the concentration degree of data across various evaluation dimensions. The second concentration is determined by summing the concentrations of the rows for all row vectors, thereby providing a global indicator for measuring the first concentration level of the entire matrix. By distinguishing different ranges of values of elements and correspondingly determining the indication values of the elements, the data processing flow can be optimized and the accuracy of data analyzing can be improved. For a value of an element greater than 1, it is directly used as the indication value, retaining the original intensity information of the data. For a value of an element with absolute value less than 1, the indication value is determined by combining the value of the element with a constant, enabling a more nuanced reflection of subtle variations in the data. For a value of an element less than −1, the absolute value of the element is used as the indication value, facilitating unified representation and simplifying subsequent data analysis and calculation processes. The approach not only improves the efficiency of data processing, but also enhances the understanding and utilization of data characteristics.

In operation 104, the first texts are determined as training samples in response to the first dispersion being greater than a first threshold and the first concentration being greater than a second threshold.

In some embodiments, the operation that the first texts are determined as training samples may be implemented in the following manner. A machine learning model is trained based on the first texts.

In some embodiments, after the above operation 104 is performed, the following processing may be further performed. A quality evaluation is performed on the first texts to obtain a quality score of each of the first texts. At least one of the first texts is determined as a target text based on the respective quality scores. A machine learning model is trained based on the target text to obtain a target machine learning model.

In some embodiments, the operation of the quality evaluation is performed on the first texts may involve multiple indicators, such as accuracy, consistency, completeness, reliability, etc. of the samples. Each text is assigned with a quality score. The score may be a comprehensive score based on the evaluation indicators, or a score for a specific indicator. The quality scores are used to determine which texts will be used for model training. Typically, only samples that meet a certain quality threshold will be selected. At least one text with the highest quality score is selected as the target text. In some cases, multiple samples may also be selected to enhance the robustness of the model. The machine learning model is trained by using the selected target text(s). During this process, the model will learn the relationships between the features and labels of the samples. After training, the target machine learning model is finally obtained, which will be used for actual prediction or classification tasks.

In some embodiments, the above machine learning model is an algorithm or method in the field of machine learning, which can learn from data and make decisions or predictions. These machine learning models automatically identify patterns in the data by analyzing a large amount of training data, and then use these patterns to predict or classify new data.

In some embodiments, the operation that the quality evaluation is performed on the first texts to obtain the quality score of each of the first texts may be implemented in the following manner. The features of the first texts are analyzed, and whether there is an outlier value or a value that does not conform to the feature distribution is checked. To verify the accuracy of the labels of the first text, a comparison between the labels and known standards or expert annotations may be made. The cross validation method is used to evaluate the performance of the first texts, ensuring the stability of the evaluation results. If different evaluation indicators vary in importance, a weight may be assigned to each indicator, and a weighted total score may be calculated. The scores of all indicators are normalized to a same range (e.g. between 0 and 1) for easier comparison. The scores of all indicators are combined to obtain a total score, which serves as the quality score of the sample.

Thus, through the quality evaluation, low-quality first texts can be identified and removed or corrected, thereby improving the overall quality of the dataset. Low-quality data may include noise, which may affect the training effect of the model. The quality evaluation helps reduce these negative effects. Using higher-quality first texts can improve the accuracy of the model, as it enables learning based on more reliable data. High-quality first texts facilitate the model to learn more generalized features, thereby achieving better performance on new and unseen data. By only using high-quality samples for training, unnecessary waste of computing resources can be reduced, thereby improving training efficiency. Under resource-limited conditions, selecting the most effective samples for training can save costs. Models trained on high-quality samples are easier to interpret, as the decisions of the models are based on reliable data. The interpretability of machine learning models can enhance user trust in model results, especially in high-risk or sensitive application fields. By employing quality evaluation to screen out the target text(s), the model selection process can be simplified, as not all samples need to be used for training every model. The quality evaluation process can be conducted periodically to ensure that models are always trained based on the latest and high-quality data. The quality evaluation results can provide support for data-driven decisions, such as sample selection, model adjustment, and resource allocation. In different application fields, such as healthcare, finance or natural language processing, specific quality evaluation indicators can ensure that the model adapts to the requirements of specific fields.

In some embodiments, if the first texts are shopping records of sample objects, then the second texts are items to be purchased. The operation that the machine learning model is trained based on the first texts may be implemented in the following manner. An item recommendation model is trained based on shopping records of sample objects to obtain a target recommendation model. The target recommendation model is invoked to perform recommended item prediction for a target object based on historical shopping records of the target object, to obtain an item(s) to be recommended for the target object and then to send the item(s) to be recommended to the target object.

In some embodiments, the operation that the item recommendation model is trained based on the shopping records of the sample objects to obtain the target recommendation model may be implemented in the following manner. For the shopping records of each of the sample objects, the item recommendation model is invoked to perform recommended item prediction for the sample object based on the shopping records of the sample object, to obtain predicted recommended items for the sample object; the predicted recommended items are combined with labeled recommended items for the sample object to determine a loss value corresponding to the sample object. The loss values corresponding to all sample objects are summed to obtain a summed loss value. The item recommendation model is trained based on the summed loss value to obtain the target recommendation model.

In some embodiments, shopping record data of each sample object is collected, and the data may include information such as a user ID, an ID of a purchased item, a purchase time, and a purchase quantity. The data are cleaned, missing values are processed, and standardization or normalization is performed on the data, and the data is encoded (e.g., one-hot encoding) to meet the input requirements of the model. The features are extracted from shopping records, and these features may include the user behavioral features (e.g., purchase frequency, purchase preferences), item attributes (e.g., category, price, score), and context information (e.g., purchase time). An appropriate machine learning model is selected based on the requirements of the recommendation system, such as collaborative filtering, content-based recommendation, hybrid recommendation model, etc. The selected model is trained by using the processed dataset. This process may include model parameter adjustment and cross-validation. The model with optimal performance is determined as the target recommendation model based on the evaluation results. The target recommendation model is invoked to perform recommended item prediction based on the historical shopping records of the target object. A list including items to be recommended is generated based on prediction results of the model. Personalized items to be recommended are sent to the target object via e-mail, short message service, application push notification, etc.

In this way, by analyzing the shopping records of each sample object, the model can provide personalized recommendations, thereby enhancing user satisfaction and loyalty. The loss values are determined by combining the predicted recommended items with the labeled recommended items of sample objects, to provide a feedback mechanism for the model, thereby facilitating to identify the error of model prediction. The loss value-based training method can be utilized to enable the model to learn more accurate recommendation patterns, thereby enhancing the performance of the recommendation system. By considering the loss values of multiple sample objects, the model can be better generalized to new users and datasets. Through the quantification of prediction mistakes, the model can be optimized to reduce prediction errors and improve recommendation accuracy. By considering the losses of multiple samples, the model is not easily over-fitted to a specific dataset, which improves the robustness of the model. By analyzing the shopping records of each sample, the value of the data can be fully exploited and rich information can be provided for the training of the target recommendation model.

In some embodiments, if the first texts are article samples, the second texts are keywords. The operation that the machine learning model is trained based on the first texts may be implemented in the following manner. An article classification model is trained based on article samples to obtain a target classification model. The target classification model is invoked to perform article classification on a target article, to obtain an article classification of the target article.

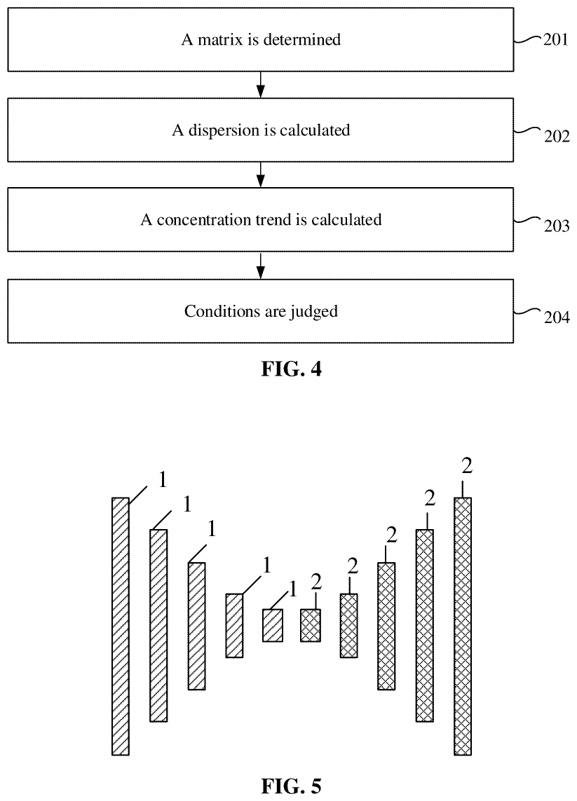

In some embodiments, the article classification model is a model in the field of machine learning, which is used to classify text data (articles) into predefined classifications. The target classification model and the article classification model described above have the same model structure. Referring to FIG. 5, FIG. 5 is a structural schematic diagram of a target classification model according to an embodiment of the disclosure. The target classification model may include a feature extraction layer 1 and a classification layer 2. The operation that the target classification model is invoked to perform article classification on the target article, to obtain the article classification of the target article may be implemented in the following manner. A feature extraction layer 1 is invoked to perform feature extraction on the target article, to obtain target text features. A classification layer 2 is invoked to perform article classification on the target article based on the target text features, to obtain the article classification of the target article.

In some embodiments, the operation that the article classification model is trained based on the article samples to obtain the target classification model may be implemented in the following manner. For each article sample, the article classification model is invoked to perform article classification on the article sample based on the article sample, to obtain a predicted classification of the article sample. A loss value corresponding to the article sample is determined based on the predicted classification y and a labeled classification of the article sample. The loss values corresponding to all article samples are summed to obtain an overall loss value. The article classification model is trained based on the overall loss value to obtain the target classification model.

In this way, the target classification model can assist in automatically archiving and organizing content, and facilitating retrieval and management. During content review, the classification model can aid in identifying content that does not comply with regulations. The target classification model can provide users with personalized content recommendations, thereby enhancing their reading satisfaction and loyalty. Users can quickly locate articles of interest through classification, thereby reducing search time. Trend analysis can be conducted based on classification results to understand the popularity of content in a specific classification. Resource wastage in manual classification can be minimized through automated classification. In the field of education, classification models can assist in classifying academic articles, which is convenient for academic research and data organization. In the legal and financial industries, classification models are used to identify sensitive or non-compliant content, aiding in risk assessment and management.

In this way, a matrix of texts is constructed, each of elements in the matrix indicates a relationship between a first text corresponding to a row to which the element belongs and a second text corresponding to a column to which the element belongs, and elements in a same row of the matrix correspond to a same first text; a first dispersion of the matrix is determined based on the relationships indicated by the elements in the matrix; a first concentration of the matrix is determined based on the relationships indicated by the elements in the matrix and the first texts; and the first texts are determined as training samples in response to the first dispersion being greater than a first threshold and the first concentration being greater than a second threshold. In this way, by constructing the matrix of texts, since the dispersion can accurately measure the difference of the relationships between the first texts and the second texts in the matrix, the concentration can accurately measure the closeness of the relationships between the first texts and the second texts, subsequent data processing is performed based on the first texts corresponding to the matrix meeting the requirements of the dispersion and the concentration. This enables effective screening of the texts for data processing, thereby effectively reducing the amount of data for data processing, and thus effectively improving the data processing performance.

Hereinafter, an exemplary application of the embodiment of the disclosure in a practical application scenario of article classification will be described.

In some embodiments, matrices are frequently utilized in machine learning, including for the feature storage, the optimization computation, etc., all of which are rely on matrices. In a matrix, if the number of zero elements of data is far more than the number of non-zero elements, and the distribution of non-zero elements is irregular, the matrix is referred to as a sparse matrix, while the opposite is referred to as a dense matrix. In the modeling process, when the sparsity of the matrix is large, the difficulty of model learning is increased, leading to poor performance. There are various scenarios and causes for the generation of sparse matrix. The sparse matrix generated in the recommendation system is common in the field of e-commerce, such as Taobao, JD.com and other online shopping websites. There are tens of thousands of commodities. Since it is objectively impossible for every customer to purchase all the commodities, the purchase records of a customer inevitably represent only a small part of the massive commodities. Therefore, the purchase records of each of numerous customers must be a sparse matrix. For the sparse matrix generated in the field of text mining: to determine whether several articles belong to the same topic, a commonly used algorithm is to first select a batch of keywords and then perform a judgment through the frequency of these keywords in different articles. There are often tens of thousands of keywords in this batch, while each article typically includes only dozens to hundreds of them. Therefore, the resulting data forms a sparse matrix. In word vector representation, a sparse matrix is generated. An article may include hundreds or thousands of different words, resulting in hundreds or thousands of the vector representation dimension of each word. When the one-hot method is employed for word representation, in a word vector corresponding to a word, only the position of the word is set to 1, while all other positions remain 0. As a result, the vectors of these words form a sparse matrix. The sparsity of a matrix is a general concept. There is no universal and applicable method for how to detect the sparsity of the matrix and how to quantitatively compare the sparsity of matrices. Generally speaking, the wider the distribution of elements in a matrix (that is, the higher the complexity or diversity of element compositions in the matrix), and the superior the matrix trend towards zero (that is, the more the overall element values of the matrix deviate from zero), the sparsity of the matrix is considered to be lower. Therefore, by accurately detecting the sparsity of the matrix and subsequently utilizing it, the matrix information can be maximally used, thereby reducing the difficulty of model learning, and improving the model performance.

In some embodiments, referring to FIG. 4, FIG. 4 is a second schematic flowchart of the method for data processing according to an embodiment of the disclosure. The method for data processing according to an embodiment of the disclosure may be implemented by operations 201 to 204 illustrated in FIG. 4.

In operation 201, a matrix is determined.

In some embodiments, assume an m*n matrix

$$A = {[ \begin{matrix}1 & 8 & … & 0 \\ 0 & 4 & … & 1 \\ … & … & … & … \\ 5 & 0 & … & 28\end{matrix} ]}_{m * n} ,$$

the sparsity of the matrix is detected (m*n represents that the matrix consists of m rows and n columns of data).

In operation 202, a dispersion is calculated.

In some embodiments, the first dispersion ω for element compositions in the matrix A is calculated. The calculation formula for the first dispersion ω is as follows:

$$ω = \frac{{Σ}_{i = 1}^{m} {Σ}_{j = 1}^{n} {I}_{1} ( {x}_{i j + 1} - {x}_{i j} ) + {I}_{2} ( {x}_{i + 1 j} - {x}_{i j} )}{k} \qquad ( 10 )$$

$$k = {\sum }_{i = 1}^{m} {\sum }_{j = 1}^{n} {I}_{3} ( {x}_{i , j} ) \qquad ( 11 )$$

$${I}_{1} ( {x}_{i , j + 1} - {x}_{i , j} ) = \{ \begin{matrix}0 , {x}_{i , j + 1} = {x}_{i , j} or j + 1 > n \\ 1 , {x}_{i , j + 1} \neq {x}_{i , j}\end{matrix} \qquad ( 12 )$$

$${I}_{2} ( {x}_{i + 1 , j} - {x}_{i , j} ) = \{ \begin{matrix}0 , {x}_{i , j + 1} = {x}_{i , j} or i + 1 > m \\ 1 , {x}_{i + 1 , j} \neq {x}_{i , j}\end{matrix} \qquad ( 13 )$$

$${I}_{3} ( {x}_{i , j} ) = \{ \begin{matrix}0 , {x}_{i , j} \neq 0 \\ 1 , {x}_{i , j} = 0\end{matrix} \qquad ( 14 )$$

Where x_{i,j} represents an element in i-th row and j-th column of the matrix A, x_{i,j+1} represents an element in i-th row and (j+1)-th column of the matrix A, and x_{i+1,j} represents an element in (i+1)-th row and j-th column of the matrix A.

Where i(x_{i,j+1}−x_{i,j}) is an indication function. When x_{i,j}≠x_{i,j}, it represents that two adjacent elements x_{i,j+1} and x in the same row are different, at this time, I₁(x_{i,j+1}−x_{i,j})=1. When x_{i,j+1}=x_{i,j}, it represents that two adjacent elements x_{i,j+1} and x_{i,j} in the same row are the same, at this time, I₁(x_{i,j+1}−x_{i,j})=0. When j+1>n, it exceeds the range of the matrix (because the matrix has a total of n columns), at this time, I₁(x_{i,j+1}−x_{i,j})=0.

Where I₂(x_{i+1,j}−x_{i,j}) is an indication function. When x_{i+1,j}≠x_{i,j}, it represents that two adjacent elements xᵢ₊₁ and x_{i,j} in the same column are different, at this time, I₂(x_{i+1,j}−x_{i,j})=1. When x_{i+1,j}=x_{i,j}, it represents that two adjacent elements x_{i+1,j} and x_{i,j} in the same column are identical, at this time, I₂(x_{i+1,j}−x_{i,j})=0. When i+1>m, it exceeds the range of the matrix (because the matrix has a total of m rows), at this time, I₂(x_{i+1,j}−x_{i,j})=0.

Where I₃(x_{i,j}) is an indication function, when x_{i,j}=0, I₃(x_{i,j})=1. When x_{i,j}≠0, I₃(x_{i,j})=0.

In some embodiments, the numerator

$${\sum }_{i = 1}^{m} {\sum }_{j = 1}^{n} {I}_{1} ( {x}_{i , j + 1} - {x}_{i , j} ) + {I}_{2} ( {x}_{i + 1 , j} - {x}_{i , j} )$$

represents that for each element x_{i,j} in the matrix A, the number of adjacent elements that are different from the element is calculated, which measures the degree of dispersion or disorder of elements in the matrix A, and a larger value represents a higher degree of dispersion or disorder of elements in the matrix. However, relying solely on the numerator may lead to some misjudgments. For example, for matrix

$$[ \begin{matrix}0 & 1 & 2 \\ 0 & 3 & 0\end{matrix} ]$$

and matrix

$$[ \begin{matrix}1 & 2 & 3 \\ 0 & 0 & 3\end{matrix} ] ,$$

both yield a numerator value of 6, but it is obvious that the degrees of sparsity of the two matrices are not consistent. The denominator k represents the number of zero elements in the matrix, and a smaller k represents that the composition of elements in the matrix is more complex. By combining the numerator with the denominator, this approach can address both the misjudgment of the numerator in this solution and the drawback of existing method that relies solely on the number of zero elements in the matrix to determine the sparsity of the matrix. The calculation method for the first dispersion ω proposed in this solution follows the principle: a larger numerator (indicating greater degree of dispersion of the elements) and a smaller denominator (indicating fewer zero elements in the matrix) result in a higher value of the first dispersion ω. The superior the first dispersion of the data, the lower the sparsity of the matrix A.

In operation 203, a concentration trend is calculated.

The concentration trend for element values in the matrix A is calculated. The calculation formula of the concentration trend γ is as follows:

$$γ = \frac{{\sum }_{i = 1}^{m} \sqrt[{a}_{i}]{{\prod }_{j = 1}^{{b}_{i}} {c}_{i , j} {log}_{2} f ( {y}_{i , j} )}}{{\sum }_{i = 1}^{m} {a}_{i}} \qquad ( 15 )$$

$$f ( {y}_{i , j} ) = \{ \begin{matrix}{y}_{i , j} , {y}_{i , j} \geq 1 \\ \vert {y}_{i , j} \vert + 1 , - 1 < {y}_{i , j} < 1 \\ \vert {y}_{i , j} \vert , {y}_{i , j} \leq - 1\end{matrix} \qquad ( 16 )$$

where in the m*n matrix, assume that the number of non-zero elements in each row is a₁, a₂, . . . aₘ, the number of elements of different values among the non-zero elements in each row is b₁, b₂, . . . , bₘ. y_{i,j} represents the element of the j-th different value in the non-zero elements of the i-th row. c_{i,j} represents the number of occurrences of y_{i,j} in the i-th row. f(y_{i,j}) is the step function. Π( ) represents the consecutive multiplication operation (such as

$${\prod }_{i = 1}^{3} i = 1 * 2 * 3 ) .$$

In some embodiments,

$$\sqrt[{a}_{i}]{{\prod }_{j = 1}^{{b}_{i}} {c}_{i , j} {log}_{2} f ( {y}_{i , j} )}$$

in the numerator represents the concentration trend of non-zero elements of the i-th row, and f(y_{i,j}) is the step function. When y_{i,j}≥1, f(y_{i,j})=y_{i,j}, at this time, log₂ f(y_{i,j})>0. The purpose of using the log₂ f(y_{i,j}) is to reduce the influence of the extreme value on the concentration trend of non-zero elements (for example, log₂ 4=2, log₂ 64=6. Suppose 64 represents an extreme value relative to 4, the difference between the two elements before processing is 60, while after processing, the difference between the two elements is 4). When −1<y_{i,j}<1, f(y_{i,j})=|y_{i,j}|+1. The reason for this design is that, when −1<y_{i,j}<1, f(y_{i,j}) is negative and may potentially be a significantly large negative value, which will cause log₂ f(y_{i,j}) to deviate severely from its actual magnitude |y_{i,j}|. Therefore, at this time, f(y_{i,j})=|y_{i,j}|+1, which may ensure that log₂ f(y_{i,j}) is positive and does not deviate from its actual magnitude |y_{i,j}|. When y_{i,j}≤−1, f(y_{i,j})=|y_{i,j}|, because the value of f(y_{i,j}) in log₂ f(y_{i,j}) cannot be less than 0, the |y_{i,j}| is taken, which essentially equivalent to the case that: when y_{i,j}>1, f(y_{i,j})=y_{i,j}. cᵢⱼ represents the number of occurrences of y_{i,j} in the i-th row. The role of c_{i,j} is equivalent to assigning a weight to each of the different non-zero elements y_{i,j}. The reason for this is that the extreme value occurs extremely infrequently, whereas the non-extreme value occurs more frequently. In this way, the influence of the extreme value on the concentration trend of non-zero elements can be further reduced. Π( ) represents the consecutive multiplication operation, and \sqrt{ } represents the square root extraction, which is intended to reduce potential large differences between different rows. The denominator

$${\sum }_{i = 1}^{m} {a}_{i}$$

represents the number of all non-zero elements in the matrix. By dividing the numerator by the denominator, the concentration trend γ of all non-zero elements is obtained. γ effectively avoids the influence of the extreme value (deviating from the normal value) in the existing method, and the concentration trend γ is used to detect the sparsity magnitude based on the magnitude of deviation of the element value from zero. The larger the concentration trend γ for element values in the matrix A, the smaller the sparsity of the matrix A.

In operation 204, conditions are judged.

In some embodiments, if the matrix A simultaneously satisfies the following conditions: ω>θ and γ>μ, it is considered that the matrix A has a smaller sparsity, that is, the matrix A is a non-sparse matrix. Otherwise, it is considered that the matrix A has a larger sparsity, that is, A is a sparse matrix. (The sparsity of the matrix is controlled from two different perspectives ω and γ, and the matrix can only be determined as a non-sparse matrix when both conditions are satisfied). Where θ and μ serve as threshold conditions, and the values of θ and μ vary depending on different scenarios.

In some embodiments, regarding how to obtain θ and μ, t θ and μ are two specific values, when a matrix simultaneously satisfies ω>θ and γ>μ, the matrix is considered to be a non-sparse matrix; and sparse matrix typically includes a large number of zero values, which means that there is less non-zero information in the input data. For some tasks, this may limit the amount of information learned by the model and thus affect the performance of the model. Deep learning models typically improve their performance by learning complex feature patterns of input data. If the input data is sparse, the model may have difficulty capturing sufficiently rich features, which may affect the final performance. θ and μ may be obtained in the following manner. For example, in the recommendation scenario, n columns of the matrix A indicate n different products, while m rows of the matrix A indicate m customers, and a number in the matrix A represents the number of times a certain customer browses or purchases a certain product. At this time, the data in the matrix A may be utilized for model training, and then the effect of the model is observed. If the effect is unsatisfactory, a new batch of data may be taken to replace the data in the matrix A, followed by model training and effect validation. Alternatively, dimensionality reduction or other operations may be performed on the matrix until an optimized model effect is achieved. At this time, for the data matrix corresponding to the optimized model, values of ω and γ are calculated. Therefore, in this scenario, θ=ω and μ=γ may be set. Thereafter, in this scenario or similar scenarios, when the model training is performed again, whether the matrix corresponding to the training data is a sparse matrix may be determined by first calculating the values of ω and γ, then comparing ω with θ and comparing γ with μ, without having to determine whether the matrix is a sparse matrix through model training and effect validation.

In some embodiments, for the sparse matrix generated in the field of text mining: in the Internet era, a large number of articles are generated every day, raising a challenge of how to distinguish these articles and then accurately recommend them to interested users. A commonly used algorithm is to set different keyword libraries for different fields, and perform a judgment based on the frequency of these keywords across different articles. The keyword libraries vary across different fields. The keyword libraries of numerous fields consist of tens of thousands of independent words. Only a small portion of these keywords can be matched in each article, resulting in data that may form a sparse matrix. When these data are used to train the classification model, it will inevitably increase the difficulty of model learning, preventing the acquisition of an optimal classification model and consequently affecting the recommendation effect for users. Therefore, the operations such as dimensionality reduction need to be performed on the matrix data, but it is necessary to detect whether the matrix is still a sparse matrix after these operations. Whether the matrix is a sparse matrix is determined by calculating the values of ω and γ, then comparing the calculated values of ω and γ with the threshold conditions θ and μ respectively. Assuming that the keyword library includes a total of 30,000 different words, and 1,000 articles are selected, a matrix of 1000*30,000 may be constructed (if the data of the 3rd row and 5th column is 2, it represents that the number of times the third article includes the fifth word is 2; alternatively, the fifth word appears twice in the third article). Given that most articles are relatively short and include only partial words of 30,000 words, most of the data in each row is zero, and at this time, the matrix must be a sparse matrix. The operations such as dimensionality reduction may be applied on the matrix data (e.g., transforming the 1000*30000 matrix into a 500*300 matrix) to obtain the matrix A. Firstly, the first dispersion ω of the matrix A is obtained based on the evaluation method of the first dispersion of the matrix proposed in this disclosure. Then, the concentration trend γ for element values in the matrix A is obtained based on the evaluation method of the concentration trend of the matrix proposed in this disclosure. Finally, whether the matrix A is a sparse matrix is determined based on the comparison results of ω and θ, as well as γ and μ. If the matrix A simultaneously satisfies ω>θ and γ>μ, it is considered that the matrix A has a smaller sparsity, i.e. the matrix A is a non-sparse matrix, the data may be used to train the model.

In some embodiments, for the comparison of sparsity between two matrices (the comparison may be made between two matrices of the same dimension or of different dimensions), ω value and γ value of the two matrices are calculated respectively. If the ω value and the γ value of a matrix are both greater than the ω value and the γ value of the other matrix, it is indicated that the sparsity of the matrix is lower than the sparsity of the other matrix. By designing the calculation method of the first dispersion for element components in the matrix, the calculation method of the concentration trend for element values in the matrix, as well as the judgment condition for sparsity, the sparsity of matrix data in a given scenario can be accurately determined, thereby improving the performance of the model during the training process. The first dispersion for element components in the matrix is used to detect the sparsity magnitude of the matrix from the perspective of the element distribution. The concentration trend for the element values in the matrix is used to detect the sparsity magnitude of the matrix from the perspective of the magnitude of deviation of the element value from zero. The embodiments of the disclosure controls the sparsity of the matrix from different perspectives, and a matrix can only be determined to be a non-sparse matrix when all conditions are simultaneously satisfied. In addition, the solution proposed in the disclosure may also be used to compare the sparsity magnitudes of two matrices (the comparison may be made between two matrices of the same dimension or of different dimensions). By designing the calculation method of the first dispersion for element components in the matrix, the calculation method of the concentration trend for element values in the matrix, as well as the judgment condition for sparsity, the sparsity of matrix data in a given scenario can be accurately determined, thereby improving the performance of the model during the training process.

It is to be understood that, in the embodiments of the disclosure, when the embodiments of the disclosure are applied to specific products or technologies, the usage of the involved text-related data requires obtaining user permission or consent. Furthermore, the collection, use and processing of relevant data must comply with the pertinent laws, regulations, and standards of the relevant countries and regions.

The implementation of the data processing device 455 according to an embodiment of the disclosure as software modules will be further described below. In some embodiments, as illustrated in FIG. 2, the software modules stored in the data processing device 455 of the memory 450 may include: a constructing module, a determining module and a data processing module. The constructing module is configured to construct a matrix of texts. Each of elements in the matrix indicates a relationship between a first text corresponding to a row to which the element belongs and a second text corresponding to a column to which the element belongs, and elements in a same row of the matrix correspond to a same first text. The determining module is configured to determine a first dispersion of the matrix based on the relationships indicated by the elements in the matrix, and determine a first concentration of the matrix based on the relationships indicated by the elements in the matrix and the first texts. The data processing module is configured to determine the first texts as training samples in response to the first dispersion being greater than a first threshold and the first concentration being greater than a second threshold.

In some embodiments, the constructing module is further configured to: compare a first text corresponding to each row of the matrix with a second text corresponding to each column of the matrix to obtain multiple comparison results, and each of the multiple comparison results represents whether the second text is in the first text; and take each of the multiple comparison results as the relationship indicated by the respective element in the matrix.

In some embodiments, the determining module is further configured to: for each of elements in the matrix, determine a second dispersion of the element based on a relationship indicated by the element and a relationship indicated by an adjacent element of the element; determine a third dispersion of the matrix based on all the determined second dispersions; and determine the first dispersion of the matrix based on the third dispersion and a preset value of the relationships.

In some embodiments, the adjacent element includes a row-adjacent element and a column-adjacent element. The determining module is further configured to: compare the relationship indicated by the element with a relationship indicated by the row-adjacent element to obtain a first comparison result, the first comparison result represents whether the relationship indicated by the element is identical to the relationship indicated by the row-adjacent element; compare the relationship indicated by the element with a relationship indicated by the column-adjacent element to obtain a second comparison result, the second comparison result represents whether the relationship indicated by the element is identical to the relationship indicated by the column-adjacent element; and determine the second dispersion of the element based on the first comparison result and the second comparison result.

In some embodiments, the determining module is further configured to: determine a first row-indication value in response to the first comparison result representing that the relationship indicated by the element is identical to the relationship indicated by the row-adjacent element; determine a second row-indication value in response to the first comparison result representing that the relationship indicated by the element is not identical to the relationship indicated by the row-adjacent element; determine a first column-indication value in response to the second comparison result representing that the relationship indicated by the element is identical to the relationship indicated by the column-adjacent element; determine a second column-indication value in response to the second comparison result representing that the relationship indicated by the element is not identical to the relationship indicated by the column-adjacent element; and determine the second dispersion based on the first row-indication value, the second row-indication value, the first column-indication value and the second column-indication value.

In some embodiments, the determining module is further configured to: determine a concentration of each of rows of the matrix based on the relationships indicated by elements in the row of the matrix; determine a second concentration of the matrix based on the concentrations of all rows of the matrix; obtain a total number of elements, each of which indicates a relationship that the second text is in the first text; determine the first concentration of the matrix based on the second concentration and the total number.

In some embodiments, the determining module is further configured to: for the relationship indicated by each element in each row of the matrix, in response to the relationship indicating that the second text corresponding to a column to which the element belongs is in the first text corresponding to a row to which the element belongs, determine an indication value of the element based on a value of the element; determine a concentration of the element based on the indication value of the element and the number of occurrences of the element in the row; and determine the concentration of each row based on the concentrations of all elements in the row.

In some embodiments, the determining module is further configured to: if the value of the element is greater than 1, determine the value of the element as the indication value of the element; if an absolute value of the value of the element is less than 1, determine the indication value of the element based on the absolute value of the value of the element and a constant; and if the value of the element is less than −1, determine an absolute value of the value of the element as the indication value of the element.

An embodiment of the disclosure provides a computer program product including a computer program or computer-executable instructions stored in a computer readable storage medium. A processor of an electronic device reads the computer-executable instructions from the computer-readable storage medium, and the processor executes the computer-executable instructions to cause the electronic device to perform the method for data processing described in embodiments of the disclosure.

An embodiment of the disclosure provides a computer-readable storage medium having stored thereon computer-executable instructions that, when executed by a processor, cause the processor to implement the method for data processing according to an embodiment of the disclosure, such as the method for data processing illustrated in FIG. 3.

In some embodiments, the computer-readable storage medium may be a memory, such as ferroelectric random access memory (FRAM), read-only memory (ROM), programmable read-only memory (PROM), erasable programmable read-only memory (EPROM), electrically erasable programmable read-only memory (EEPROM), flash memory, magnetic surface memory, optical disc, or compact disk read-only memory (CD-ROM). It may also be a variety of electronic devices including one or any combination of the above-mentioned memories.

In some embodiments, the computer-executable instructions may take the form of programs, software, software modules, scripts, or code, written in any form of programming language (including compiled or interpreted languages, or declarative or procedural languages). Moreover, the computer-executable instructions may be deployed in any form, including as standalone programs or as modules, components, subroutines, or other units suitable for use in a computing environment.

As an example, the computer-executable instructions may, but do not necessarily, correspond to files in a file system. The computer-executable instructions may be stored as part of a file that holds other programs or data, for example, stored in one or more scripts within a hyper text markup language (HTML) document, in a single file dedicated to the program in question, or in multiple collaborative files (e.g., files storing one or more modules, subroutines, or code segments).

As an example, the computer-executable instructions may be deployed for execution on a single electronic device, or on multiple electronic devices located at a single site, or alternatively, on multiple electronic devices distributed across multiple sites and interconnected via a communication network.

To sum up, the embodiments of the disclosure has the following beneficial effects.
(1). A matrix of texts is constructed, each of elements in the matrix indicates a relationship between a first text corresponding to a row to which the element belongs and a second text corresponding to a column to which the element belongs, and elements in a same row of the matrix correspond to a same first text; a first dispersion of the matrix is determined based on the relationships indicated by the elements in the matrix; a first concentration of the matrix is determined based on the relationships indicated by the elements in the matrix and the first texts; and the first texts are determined as training samples in response to the first dispersion being greater than a first threshold and the first concentration being greater than a second threshold. In this way, by constructing the matrix of texts, since the dispersion can accurately measure the difference of the relationships between the first texts and the second texts in the matrix, the concentration can accurately measure the closeness of the relationships between the first texts and the second texts, subsequent data processing is performed based on the first texts corresponding to the matrix meeting the requirements of the dispersion and the concentration. This enables effective screening of the texts for data processing, thereby effectively reducing the amount of data for data processing, and thus effectively improving the data processing performance.
(2). By determining the row vector of each text and concatenating them into a matrix, a structured data representation may be obtained, which makes the data easy to be processes and analyzed. Each column of the matrix represents one feature (one second text), which makes each feature clearly identifiable, facilitating the algorithm to understand and extract the relationships between features. The form of the matrix allows data to be processed using matrix operations, which are typically highly optimized in numerical computing libraries, enabling efficient handling of large-scale text data. The matrix provides an intuitive tool for analyzing the distribution of texts. By observing the matrix, one can quickly recognize which samples include a specific second text, which second texts are more common, and the similarity between samples, and the like. When matrices are used to train a machine learning model, the model can more easily identify and learn patterns and regularities included in samples. This contributes to enhancing the performance of the model, such as classification accuracy or prediction capability.
(3). By calculating the second dispersion of each element in the matrix, a more detailed analysis of the dataset is enabled. This approach captures local variability, which may help reveal the subtle relationships between sample features. Considering the relationships between adjacent elements can improve the ability to identify local patterns, which may help to improve the accuracy of subsequent text data processing. All the second dispersions are summed to obtain a third dispersion, which provides a global metric for evaluating the variability of the whole matrix. By performing the summation, a single indicator reflecting the variability of the whole matrix may be obtained, thereby facilitating a global understanding of the characteristics of the dataset. The first dispersion can serve as a comparison benchmark for the variability between different matrices. The introduction of the reference value standardizes the calculation of the first dispersion, helping to eliminate the influence of different element values, and rendering the first dispersion indicator more stable and consistent. The third dispersion is divided by the sum of the reference values to obtain the first dispersion of the matrix, which is a normalization process. Through normalization, the resulting first dispersion indicator is independent of the magnitude of the original data values, making the indicator more universally applicable and comparable. This approach facilitates more accurate capture and quantification of data variability, providing additional means for data analysis and visualization while aiding in a better understanding of the inherent characteristics of the initial dataset.
(4) Clear thresholds and judgment conditions make the evaluation process easy to understand and facilitate operations in practical applications. The consistency of evaluation can enhance the reliability and trustworthiness of the whole evaluation system. Distinguishing whether evaluation parameters meet preset evaluation indexes based on the thresholds of the evaluation parameters and the first dispersion, which is helpful to identify the characteristics of datasets or samples. Based on evaluation results, more refined processing may be performed on the dataset, such as conducting additional analysis or adjustment on samples that do not meet the conditions. In the field of machine learning, this is helpful to select features with good characteristics, thereby potentially improving the performance of the model. Based on evaluation results, decision makers can optimize resource allocation, such as investing more research and development resources in areas that do not meet the conditions. By analyzing the evaluation results, the evaluation criteria (such as the thresholds of the evaluation parameters and the first dispersion) can be continuously adjusted and refined to adapt to new data or evaluation requirements.
(5). Through the quality evaluation, low-quality texts can be identified and removed or corrected, thereby improving the overall quality of the dataset. Low-quality data may include noise, which may adversely affect the training effect of the model. The quality evaluation helps reduce these negative effects. Using higher-quality texts can improve the accuracy of the model, as it enables learning based on more reliable data. High-quality texts facilitate the model to learn more generalized features, thereby achieving better performance on new and unseen data. By only using high-quality samples for training, unnecessary waste of computing resources can be reduced, thereby improving training efficiency. Under resource-limited conditions, selecting the most effective samples for training can save costs. Models trained on high-quality samples are easier to interpret, as the decisions of the models are based on reliable data. The interpretability of machine learning models can enhance user trust in model results, especially in high-risk or sensitive application fields. By employing quality evaluation to screen out the target text(s), the model selection process can be simplified, as not all samples need to be used for training every model. The quality evaluation process can be conducted periodically to ensure that models are always trained based on the latest and high-quality data. The quality evaluation results can provide support for data-driven decisions, such as sample selection, model adjustment, and resource allocation. In different application fields, such as healthcare, finance or natural language processing, specific quality evaluation indicators can ensure that the model adapts to the requirements of specific fields.
(6). By analyzing the shopping records of each sample object, the model can provide personalized recommendations, thereby enhancing user satisfaction and loyalty. The loss values are determined by combining the predicted recommended items with the labeled recommended items of sample objects, to provide a feedback mechanism for the model, thereby facilitating to identify the error of model prediction. The loss value-based training method can be utilized to enable the model to learn more accurate recommendation patterns, thereby enhancing the performance of the recommendation system. By considering the loss values of multiple sample objects, the model can be better generalized to new users and datasets. Through the quantification of prediction mistakes, the model can be optimized to reduce prediction errors and improve recommendation accuracy. By considering the losses of multiple samples, the model is not easily over-fitted to a specific dataset, which improves the robustness of the model. By analyzing the shopping records of each sample, the value of the data can be fully exploited and rich information can be provided for the training of the target recommendation model.
(7). The target classification model can assist in automatically archiving and organizing content, and facilitating retrieval and management. During content review, the classification model can aid in identifying content that does not comply with regulations. The target classification model can provide users with personalized content recommendations, thereby enhancing their reading satisfaction and loyalty. Users can quickly locate articles of interest through classification, thereby reducing search time. Trend analysis can be conducted based on classification results to understand the popularity of content in a specific classification. Resource wastage in manual classification can be minimized through automated classification. In the field of education, classification models can assist in classifying academic articles, which is convenient for academic research and data organization. In the legal and financial industries, classification models are used to identify sensitive or non-compliant content, aiding in risk assessment and management.
(8) For the comparison of sparsity between two matrices (the comparison may be made between two matrices of the same dimension or of different dimensions), ω value and γ value of the two matrices are calculated respectively. If the ω value and the γ value of a matrix are both greater than the ω value and the γ value of the other matrix, it is indicated that the sparsity of the matrix is lower than the sparsity of the other matrix. By designing the calculation method of the first dispersion for element components in the matrix, the calculation method of the concentration trend for element values in the matrix, as well as the judgment condition for sparsity, the sparsity of matrix data in a given scenario can be accurately determined, thereby improving the performance of the model during the training process. The first dispersion for element components in the matrix is used to detect the sparsity magnitude of the matrix from the perspective of the element distribution. The concentration trend for the element values in the matrix is used to detect the sparsity magnitude of the matrix from the perspective of the magnitude of deviation of the element value from zero. The embodiments of the disclosure controls the sparsity of the matrix from different perspectives, and a matrix can only be determined to be a non-sparse matrix when all conditions are simultaneously satisfied. In addition, the solution proposed in the disclosure may also be used to compare the sparsity magnitudes of two matrices (the comparison may be made between two matrices of the same dimension or of different dimensions). By designing the calculation method of the first dispersion for element components in the matrix, the calculation method of the concentration trend for element values in the matrix, as well as the judgment condition for sparsity, the sparsity of matrix data in a given scenario can be accurately determined, thereby improving the performance of the model during the training process.

The embodiments described above are merely exemplary and are not intended to limit the scope of the disclosure. Any modifications, equivalent substitutions and improvements, or the like made within the spirit and scope of the disclosure shall be included within the scope of protection of the disclosure.

1. A method for data processing, performed by an electronic device, comprising:
constructing a matrix, wherein each of elements in the matrix indicates a relationship between a first text corresponding to a row to which the element belongs and a second text corresponding to a column to which the element belongs;
determining a first dispersion of the matrix based on the relationships indicated by the elements in the matrix;
determining a first concentration of the matrix based on the relationships indicated by the elements in the matrix and first texts corresponding to rows in the matrix; and
determining the first texts as training samples in response to the first dispersion of the matrix being greater than a first threshold and the first concentration of the matrix being greater than a second threshold.

2. The method of claim 1, wherein the relationship between the first text and the second text represents whether the second text is in the first text.

3. The method of claim 1, wherein determining the first dispersion of the matrix based on the relationships indicated by the elements in the matrix comprises:
for each of the elements in the matrix, determining a second dispersion of the element based on the relationship indicated by the element and a relationship indicated by an adjacent element of the element;
determining a third dispersion of the matrix based on the second dispersions of the elements in the matrix; and
determining the first dispersion of the matrix based on the third dispersion of the matrix and a preset value of the relationships indicated by the elements in the matrix.

4. The method of claim 3, wherein the adjacent element comprises a row-adjacent element and a column-adjacent element, and determining the second dispersion of the element based on the relationship indicated by the element and the relationship indicated by the adjacent element of the element comprises:
comparing the relationship indicated by the element and a relationship indicated by the row-adjacent element to obtain a first comparison result, wherein the first comparison result represents whether the relationship indicated by the element is identical to the relationship indicated by the row-adjacent element;
comparing the relationship indicated by the element and a relationship indicated by the column-adjacent element to obtain a second comparison result, wherein the second comparison result represents whether the relationship indicated by the element is identical to the relationship indicated by the column-adjacent element; and
determining the second dispersion of the element based on the first comparison result and the second comparison result.

5. The method of claim 4, wherein determining the second dispersion of the element based on the first comparison result and the second comparison result comprises:
determining a first row-indication value in response to the first comparison result representing that the relationship indicated by the element is identical to the relationship indicated by the row-adjacent element;
determining a second row-indication value in response to the first comparison result representing that the relationship indicated by the element is not identical to the relationship indicated by the row-adjacent element;
determining a first column-indication value in response to the second comparison result representing that the relationship indicated by the element is identical to the relationship indicated by the column-adjacent element;
determining a second column-indication value in response to the second comparison result representing that the relationship indicated by the element is not identical to the relationship indicated by the column-adjacent element; and
determining the second dispersion of the element based on the first row-indication value, the second row-indication value, the first column-indication value and the second column-indication value.

6. The method of claim 1, wherein determining the first concentration of the matrix based on the relationships indicated by the elements in the matrix and the first texts corresponding to the rows in the matrix comprises:
determining a concentration of each of the rows of the matrix based on relationships indicated by elements in the row of the matrix;
determining a second concentration of the matrix based on the concentrations of the rows of the matrix;
obtaining a total number of elements, each of which indicates a relationship that the second text is in the first text; and
determining the first concentration of the matrix based on the second concentration and the total number.

7. The method of claim 6, wherein determining the concentration of each of the rows of the matrix based on the relationships indicated by the elements in the row of the matrix comprises:
for the relationship indicated by each element in each of the rows of the matrix, in response to the relationship indicating that a second text corresponding to a column to which the element belongs is in a first text corresponding to a row to which the element belongs, determining an indication value of the element based on a value of the element;
determining a concentration of the element based on the indication value of the element and a number of occurrences of the element in the row; and
determining the concentration of the row based on the concentrations of the elements in the row.

8. An electronic device, comprising:
a processor; and
a memory, configured to store computer-executable instructions runnable on the processor;
wherein the processor is configured to:
construct a matrix, wherein each of elements in the matrix indicates a relationship between a first text corresponding to a row to which the element belongs and a second text corresponding to a column to which the element belongs;
determine a first dispersion of the matrix based on the relationships indicated by the elements in the matrix;
determine a first concentration of the matrix based on the relationships indicated by the elements in the matrix and first texts corresponding to rows in the matrix; and
determine the first texts as training samples in response to the first dispersion of the matrix being greater than a first threshold and the first concentration of the matrix being greater than a second threshold.

9. The electronic device of claim 8, wherein the relationship between the first text and the second text represents whether the second text is in the first text.

10. The electronic device of claim 8, wherein the processor is further configured to:
for each of the elements in the matrix, determine a second dispersion of the element based on the relationship indicated by the element and a relationship indicated by an adjacent element of the element;
determine a third dispersion of the matrix based on the second dispersions of the elements in the matrix; and
determine the first dispersion of the matrix based on the third dispersion of the matrix and a preset value of the relationships indicated by the elements in the matrix.

11. The electronic device of claim 10, wherein the adjacent element comprises a row-adjacent element and a column-adjacent element, and the processor is further configured to:
compare the relationship indicated by the element and a relationship indicated by the row-adjacent element to obtain a first comparison result, wherein the first comparison result represents whether the relationship indicated by the element is identical to the relationship indicated by the row-adjacent element;
compare the relationship indicated by the element and a relationship indicated by the column-adjacent element to obtain a second comparison result, wherein the second comparison result represents whether the relationship indicated by the element is identical to the relationship indicated by the column-adjacent element; and
determine the second dispersion of the element based on the first comparison result and the second comparison result.

12. The electronic device of claim 11, wherein the processor is further configured to:
determine a first row-indication value in response to the first comparison result representing that the relationship indicated by the element is identical to the relationship indicated by the row-adjacent element;
determine a second row-indication value in response to the first comparison result representing that the relationship indicated by the element is not identical to the relationship indicated by the row-adjacent element;
determine a first column-indication value in response to the second comparison result representing that the relationship indicated by the element is identical to the relationship indicated by the column-adjacent element;
determine a second column-indication value in response to the second comparison result representing that the relationship indicated by the element is not identical to the relationship indicated by the column-adjacent element; and
determine the second dispersion of the element based on the first row-indication value, the second row-indication value, the first column-indication value and the second column-indication value.

13. The electronic device of claim 8, wherein the processor is further configured to:
determine a concentration of each of the rows of the matrix based on relationships indicated by elements in the row of the matrix;
determine a second concentration of the matrix based on the concentrations of the rows of the matrix;
obtain a total number of elements, each of which indicates a relationship that the second text is in the first text; and
determine the first concentration of the matrix based on the second concentration and the total number.

14. The electronic device of claim 13, wherein the processor is further configured to:
for the relationship indicated by each element in each of the rows of the matrix, in response to the relationship indicating that a second text corresponding to a column to which the element belongs is in a first text corresponding to a row to which the element belongs, determine an indication value of the element based on a value of the element;
determine a concentration of the element based on the indication value of the element and a number of occurrences of the element in the row; and
determine the concentration of the row based on the concentrations of the elements in the row.

15. A non-transitory computer-readable storage medium having stored thereon computer-executable instructions that, when executed by a processor, implement a method for data processing, wherein the method comprises:
constructing a matrix, wherein each of elements in the matrix indicates a relationship between a first text corresponding to a row to which the element belongs and a second text corresponding to a column to which the element belongs;
determining a first dispersion of the matrix based on the relationships indicated by the elements in the matrix;
determining a first concentration of the matrix based on the relationships indicated by the elements in the matrix and first texts corresponding to rows in the matrix; and
determining the first texts as training samples in response to the first dispersion of the matrix being greater than a first threshold and the first concentration of the matrix being greater than a second threshold.

16. The non-transitory computer-readable storage medium of claim 15, wherein the relationship between the first text and the second text represents whether the second text is in the first text.

17. The non-transitory computer-readable storage medium of claim 15, wherein determining the first dispersion of the matrix based on the relationships indicated by the elements in the matrix comprises:
for each of the elements in the matrix, determining a second dispersion of the element based on the relationship indicated by the element and a relationship indicated by an adjacent element of the element;
determining a third dispersion of the matrix based on the second dispersions of the elements in the matrix; and
determining the first dispersion of the matrix based on the third dispersion of the matrix and a preset value of the relationships indicated by the elements in the matrix.

18. The non-transitory computer-readable storage medium of claim 17, wherein the adjacent element comprises a row-adjacent element and a column-adjacent element, and determining the second dispersion of the element based on the relationship indicated by the element and the relationship indicated by the adjacent element of the element comprises:
comparing the relationship indicated by the element and a relationship indicated by the row-adjacent element to obtain a first comparison result, wherein the first comparison result represents whether the relationship indicated by the element is identical to the relationship indicated by the row-adjacent element;
comparing the relationship indicated by the element and a relationship indicated by the column-adjacent element to obtain a second comparison result, wherein the second comparison result represents whether the relationship indicated by the element is identical to the relationship indicated by the column-adjacent element; and
determining the second dispersion of the element based on the first comparison result and the second comparison result.

19. The non-transitory computer-readable storage medium of claim 18, determining the second dispersion of the element based on the first comparison result and the second comparison result comprises:
determining a first row-indication value in response to the first comparison result representing that the relationship indicated by the element is identical to the relationship indicated by the row-adjacent element;
determining a second row-indication value in response to the first comparison result representing that the relationship indicated by the element is not identical to the relationship indicated by the row-adjacent element;
determining a first column-indication value in response to the second comparison result representing that the relationship indicated by the element is identical to the relationship indicated by the column-adjacent element;
determining a second column-indication value in response to the second comparison result representing that the relationship indicated by the element is not identical to the relationship indicated by the column-adjacent element; and
determining the second dispersion of the element based on the first row-indication value, the second row-indication value, the first column-indication value and the second column-indication value.

20. The non-transitory computer-readable storage medium of claim 15, wherein determining the first concentration of the matrix based on the relationships indicated by the elements in the matrix and the first texts corresponding to the rows in the matrix comprises:
determining a concentration of each of the rows of the matrix based on relationships indicated by elements in the row of the matrix;
determining a second concentration of the matrix based on the concentrations of the rows of the matrix;
obtaining a total number of elements, each of which indicates a relationship that the second text is in the first text; and
determining the first concentration of the matrix based on the second concentration and the total number;
wherein determining the concentration of each of the rows of the matrix based on the relationships indicated by the elements in the row of the matrix comprises:
for the relationship indicated by each element in each of the rows of the matrix, in response to the relationship indicating that a second text corresponding to a column to which the element belongs is in a first text corresponding to a row to which the element belongs, determining an indication value of the element based on a value of the element;
determining a concentration of the element based on the indication value of the element and a number of occurrences of the element in the row; and
determining the concentration of the row based on the concentrations of the elements in the row.
